(19) United States
(12) Patent Application Publication
(10) Pub. No.: US 2011/0213629 A1
(43) Pub. Date: Sep. 1, 2011

(54) CAR SHARING

(76) Inventors: Shelby Clark, Cambridge, MA (US); Gus Holcomb, Cambridge, MA (US); David Brook, Portland, OR (US); Tara Reeves, London (GB); Nabeel Al-Kady, Alexandria (EG); Jonah Bliss, San Francisco, CA (US); Robert Guinn, Cambridge, MA (US)

(21) Appl. No.: 13/037,062

(22) Filed: Feb. 28, 2011

Related U.S. Application Data
(60) Provisional application No. 61/309,320, filed on Mar. 1, 2010.
(60) Provisional application No. 61/409,769, filed on Nov. 3, 2010.

(51) Int. Cl. G06Q 99/00; G06Q 10/00; G06Q 30/00

(52) U.S. Cl. 705/5; 705/1.1; 705/27.1

(57) ABSTRACT

Among other things, through an online site, owners of assets and borrowers of assets can arrange sharing transactions with respect to the assets. Online confirmation is provided to the owners and the borrowers that the arranged sharing transactions have been covered by insurance. Completion of the arranged sharing transactions is managed using information from electronic devices associated with the assets.

### BACKGROUND

This application relates to and claims the benefit of U.S. provisional patent application Ser. 61/309,320, filed Mar. 1, 2010, and of U.S. provisional patent application Ser. 61/409,769, filed Nov. 3, 2010, both incorporated here by reference in their entirety.

This description relates to car sharing.

In typical car sharing, such as the system operated by ZipCar™, a customer can pick up and return a car, owned by ZipCar, at an assigned commercial parking spot controlled by the company.

### SUMMARY

Among the aspects, features, and implementations of the car sharing that we describe below are the following.

In general, in an aspect, through an online site, owners of assets and borrowers of assets can arrange sharing transactions with respect to the assets. Online confirmation is provided to the owners and the borrowers that the arranged sharing transactions have been automatically covered by insurance. Using information from electronic devices associated with the assets, completion of the arranged sharing transactions is managed.

Implementations may include one or more of the following features. The enabling of the owners and borrowers to arrange the sharing transactions includes enabling the owners to offer the assets at designated times or ranges of times. The enabling of the owners and borrowers to arrange the sharing transactions includes enabling the owners to offer the assets at designated places. The enabling of the owners and borrowers to arrange the sharing transactions includes enabling the borrowers to express their interest in borrowing assets at designated times or ranges of times. The enabling of the owners and borrowers to arrange the sharing transactions includes enabling the borrowers to express their interest in borrowing assets at designated places. The assets include vehicles. The assets include cars. Each of the assets has a home location, and the sharing transaction may begin, end, or both at the home location. In some implementations, the sharing transactions for a given asset may begin at different locations depending on the time at which the sharing period begins (such as the owner's home or the train station from which the owner commutes. In some implementations, the owner and borrower in a given transaction live near to one another, though this is not required. Each of the sharing transactions is defined in terms of a time period during which the asset is to be shared with the borrower. The online site enables borrowers to identify assets that are to be the subjects of the sharing transactions and identifies times or ranges of times for the sharing transactions. The online site enables owners to identify assets that are to be the subjects of the sharing transactions and identifies times or ranges of times for the sharing transactions. The electronic devices track the locations of the assets. The sharing transactions involve periods of time shorter than one day. The sharing transactions carry fees paid by the borrowers for the benefit of the owners.

In general, in an aspect, a car-sharing method includes, through an online site, enabling owners of cars to offer them for sharing at designated times and in designated locations, for money; through an online site, enabling borrowers of cars to arrange to borrow available cars at the designated times and in the designated locations, for money; centrally arranging for insurance automatically to apply to the sharing of the cars; and using information received from electronics about the locations and identities of the cars, to manage the execution of the sharing of the cars.

In general, in an aspect, ongoing information is received about assets that belong to respective owners and are available for borrowing. A determination is made whether the respective assets will be immobile and available for borrowing at specific times in the vicinities of specific locations. Prospective borrowers are informed of the locations and times at which the respective assets will be immobile and available for borrowing.

Implementations may include one or more of the following features. The assets include vehicles. Information about reservations is received from prospective borrowers of the assets. Each of the reservations identifies a time when the borrower wants to pick up a vehicle and a geographical vicinity in which he wants to pick up the vehicle at that time. A prospective borrower is informed when a vehicle is available at a time and in a vicinity that corresponds to a reservation of the borrower. The reservations are received at an online site. The assets are privately owned. The assets include cars. The time when the borrower wants to pick up an asset is a specific time. The time when the borrower wants to pick up an asset is a range of times. The geographical vicinity is associated with a specific home location. The geographical vicinity contains a specific home location. The home location includes a home of an owner of the asset. Whether each of the assets is immobile is determined by whether the asset has moved at least a certain distance within a predefined period of time. The information about the locations of assets is generated by GPS. Whether the asset will be immobile within the vicinity at the time when the borrower wants to pick it up is based on information about reservations made by borrowers for the assets. A borrower is notified of the location at which the asset is immobile once the determination has been made that the asset will be immobile at that location and the intended time. The prospective borrowers are notified by sending them messages.

Implementations may include one or more of the following features. Insurance includes commercial insurance for which the host or manager of the system is a named insured, the borrowers and owners of the cars are additional named insured during the sharing periods, the borrowed car is a covered vehicle, and the borrower is a covered person. The insurance can be made the primary coverage except when the borrower has insurance that applies. When a borrower is using a car during a sharing period, the car, the borrower, and the owner are automatically covered under the commercial policy if needed, without any action needed by the owner, the borrower, or the host of the sharing system.

In general, in an aspect, a car that is owned by a private individual carries electronics to send information to a car sharing service that includes the location of the car and an identifier of the car.

These and other aspects and features, and combinations of them, can be expressed as methods, methods of doing business, program products, apparatus, systems, components, means or steps for performing functions, and in other ways.

Other aspects and features will become apparent from the following description and from the claims.

### DESCRIPTION

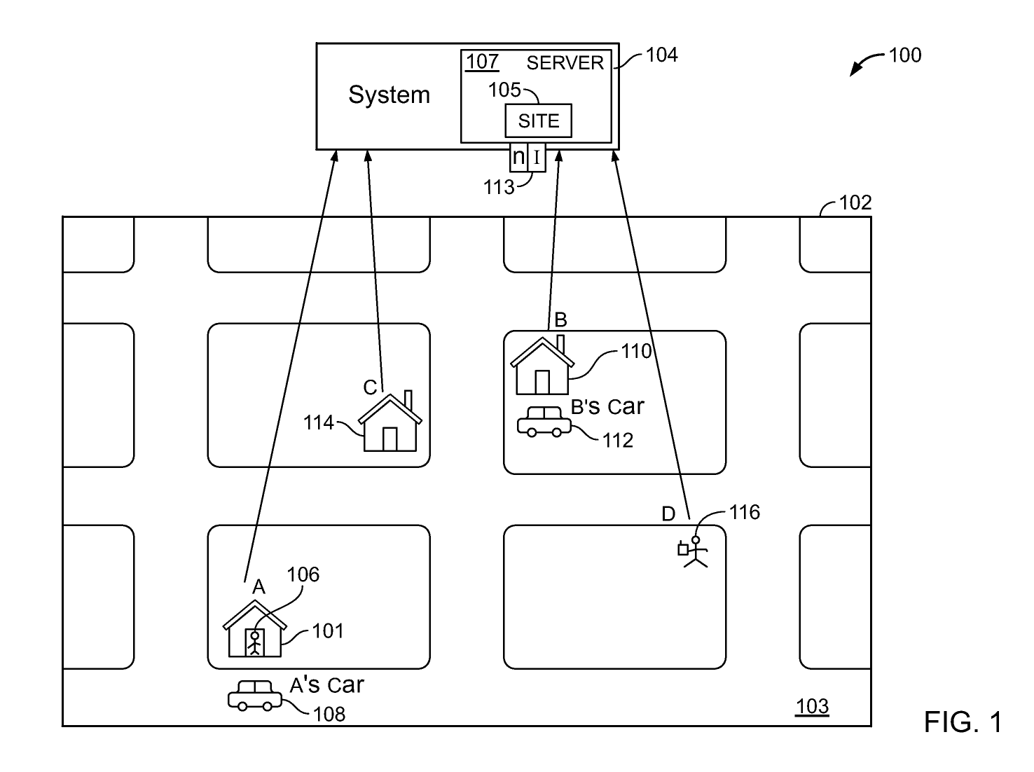

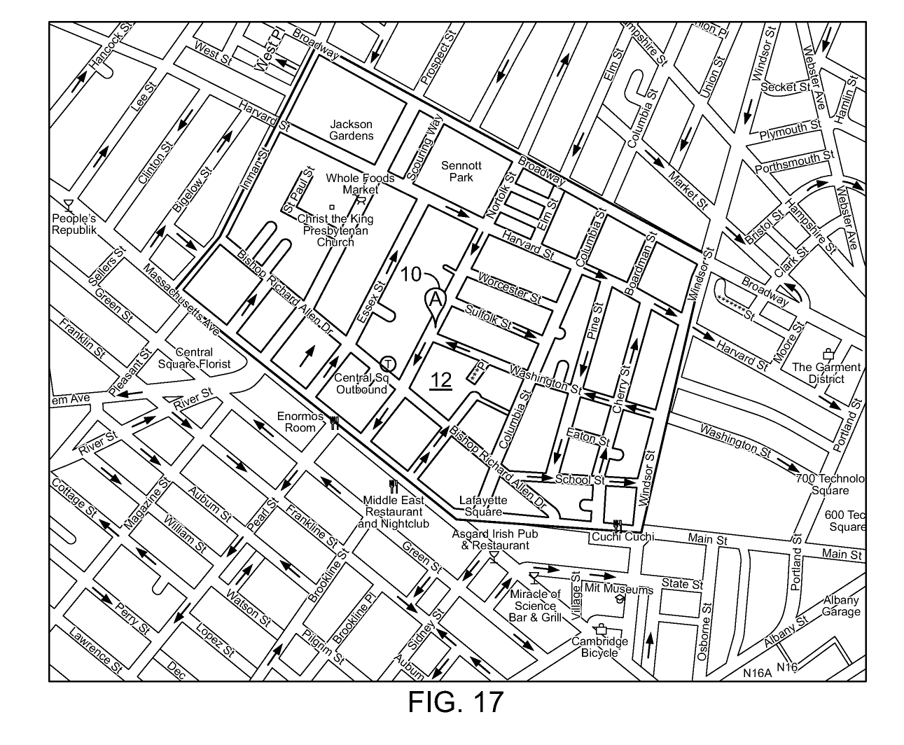

FIGS. 1 and 17 are maps.

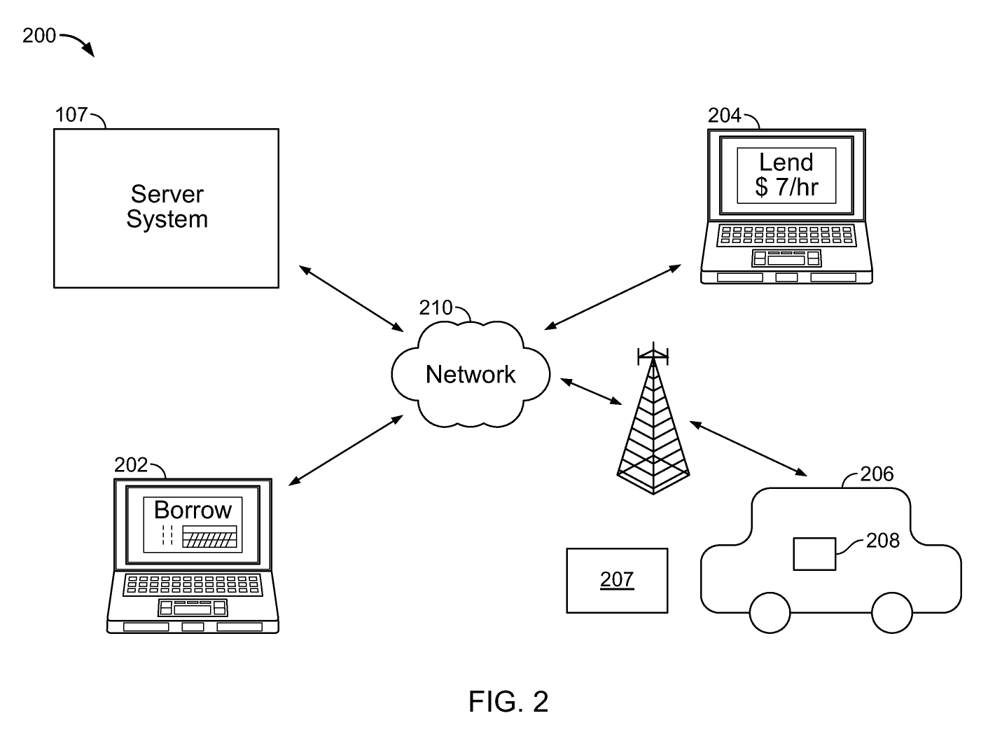

FIGS. 2-4 and 26-27 are block diagrams.

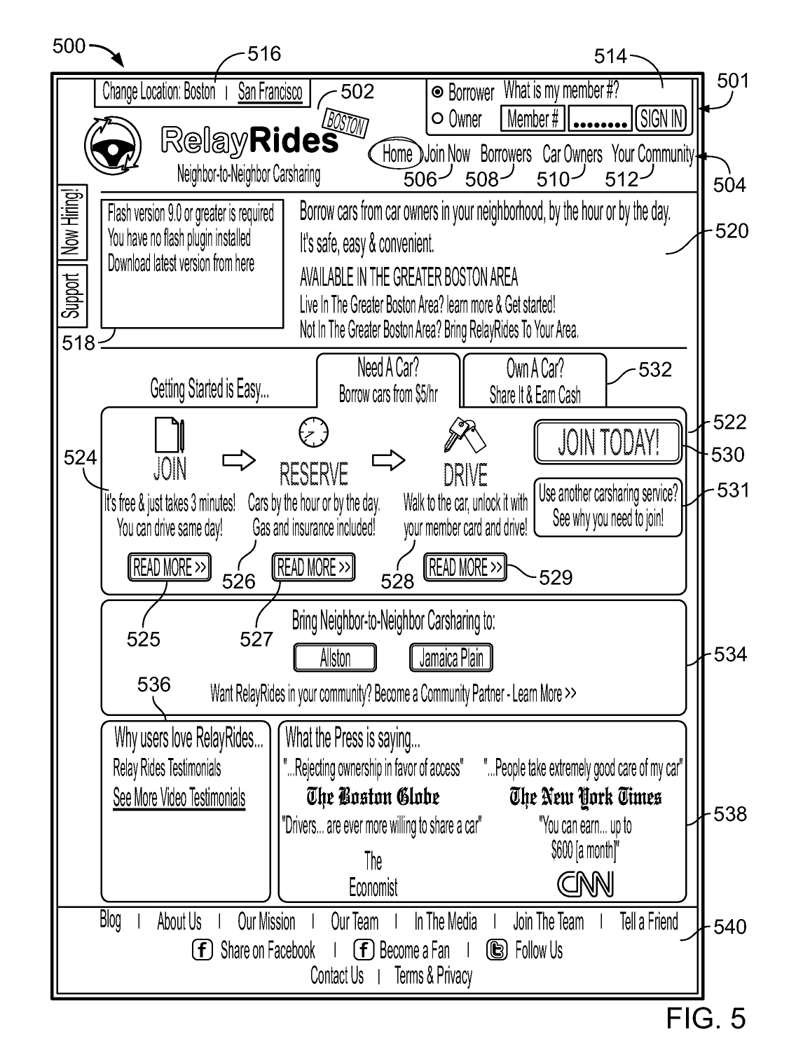

FIGS. 5-16, and 20-22 are screenshots.

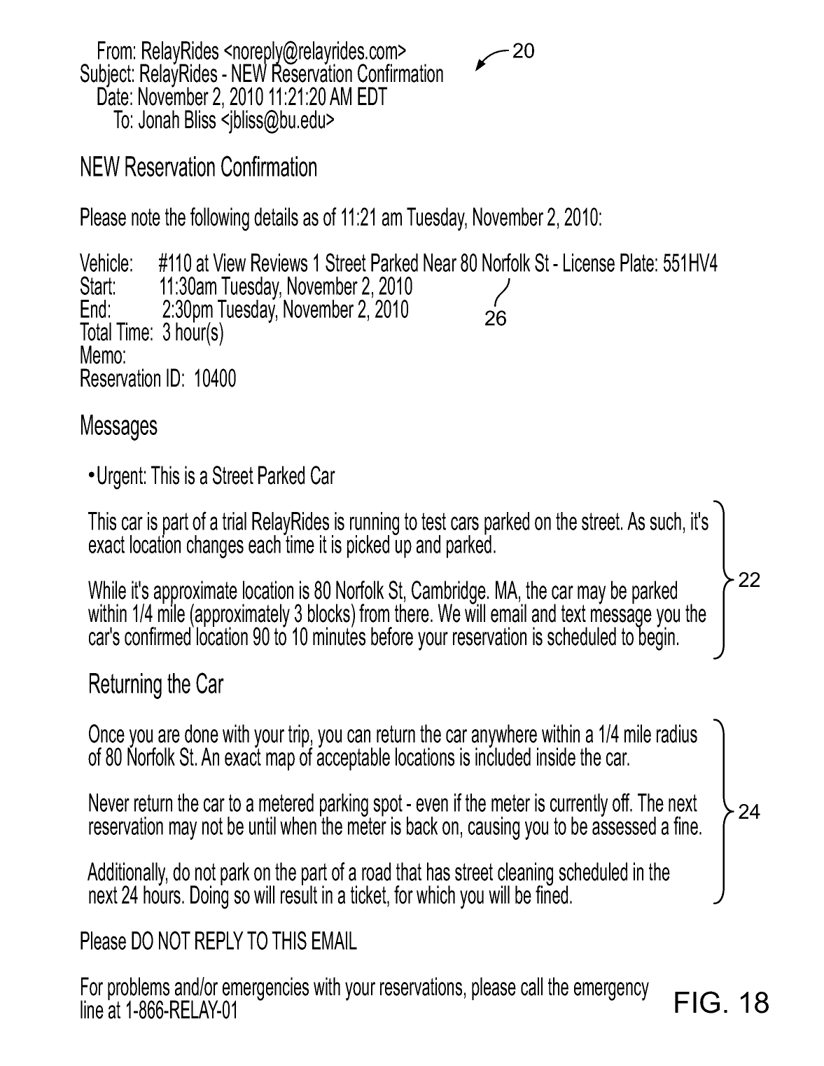

FIG. 18 is a message.

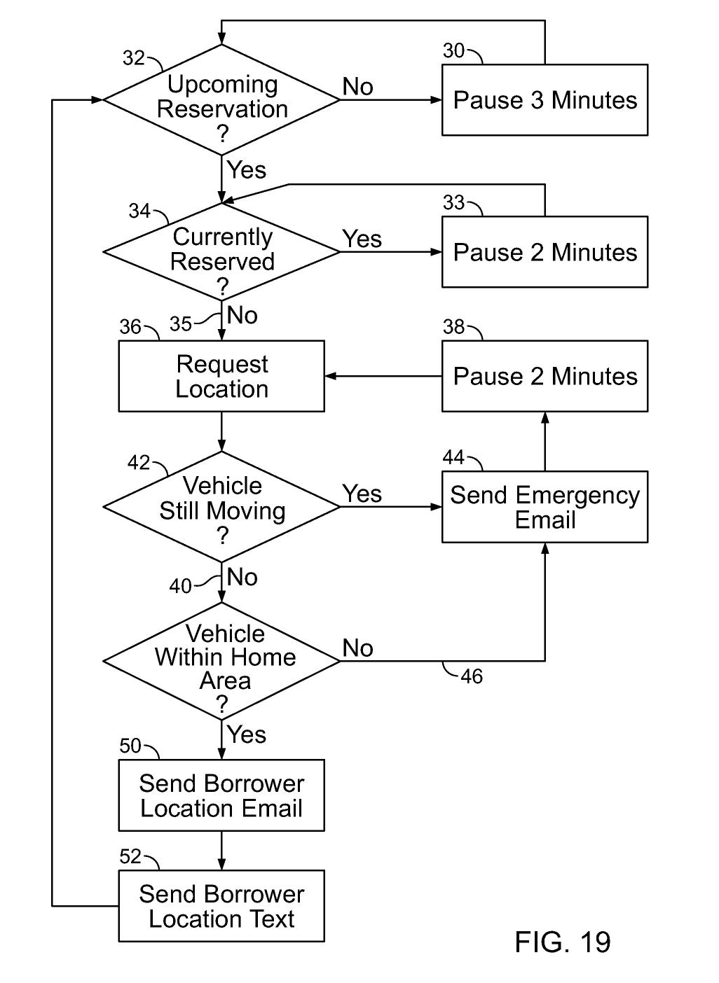

FIGS. 19 and 23-25 are flow diagrams.

As described here, car sharing is offered in a mode in which the cars are not part of a fleet owned by a company that hosts and manages the system (as in the case of a conventional car rental or car sharing company). Rather the cars are owned, for example, by private owners, who make them available for use (or, in other words, sharing or borrowing) by car borrowers for fees by using a car sharing system of the kind described here. The host or manager of the car sharing system provides an online platform and technology (including devices in the cars) that enable the owners and borrowers to initiate, manage, and complete sharing transactions involving the cars. The system provides insurance coverage that automatically applies to the sharing transactions and covers the borrower, the owner, and the car. The insurance is separate from the automatically applied insurance that covers the car and the owner of the car when the car is being used by the owner in the usual way rather than being used in a sharing transaction. The insurance is excess over any insurance that may cover the borrower, but the borrower is not required to provide insurance.

In the mode of car sharing described here, the borrower pays a fee for the car (and may pay a fee to be a participant in the system), the owners of the cars get paid for uses of their cars by others, and the host is paid a fee (from the membership and sharing fees) for providing the service, and may generate other profit through advertising and other revenue streams.

Although we use the example of cars as the assets that are the subjects of the sharing transactions between owners and borrowers, the car sharing system described here could be used for a wide variety of assets belonging to owners and used at times by borrowers. The assets could include, for example, any kind of land, sea, or airborne vehicles, tools, equipment, or other devices that are subject to being moved and used by different parties at different times. When we use the word car (including as part of other terms, such as car sharing system), we generally mean to refer to any kind of asset, not only to cars.

We use the term host (or manager) to include, for example, a party that is typically neither the owner nor the user or borrower of an asset that is subject to a sharing transaction but provides an online portal or platform or mode of use (such as the World Wide Web or client server applications running on mobile devices and mobile device servers) that enables owners and borrowers to initiate, manage, and complete sharing transactions electronically. The host or manager also can be in charge of managing the completion of the sharing transaction that has been set up between an owner and a borrower, for example, by helping both parties to set up the transaction (by identifying the asset, the time period, the location of the asset, the fee, and the parties, among other things), and then by reminding them of the start and end of the sharing period, tracking the location of the asset, handling the transfer of the fee, arranging insurance, and other aspects of operating the system.

We use the term “sharing transaction” broadly to include, for example, any agreement, contract, understanding, course of conduct, behavior, or other features involving an owner or controller of an asset (e.g., a car) allowing a borrower to use it. Typically we mean that the borrower uses the car for a limited period (an hour, a day, a week, for example) and then returns the asset to the owner who can use it herself again. We sometimes use the term “sharing period” to refer, for example, to the period beginning when the borrower takes possession of the asset being shared and ending when the borrower relinquishes possession. We sometimes use the phrase “in-progress sharing” to refer, for example, to what the borrower is doing during the sharing period. And we sometimes use the phrase “planned car sharing transaction” to refer, for example, to a sharing transaction that has been arranged between a borrower and an owner but has not yet reached the stage of in-progress sharing; that is, the sharing period has not begun. We use the phrase sharing transaction broadly to include, for example, any planned, in-progress, or past sharing situation that occurs in the car sharing system.

The host or manager could be an entity that manages the asset sharing system as its primary activity or could be an entity engaged in another business and for which the asset sharing system is a secondary activity. This asset sharing could be a feature of an already existing car sharing venture. For example, a conventional rental car company could offer the car sharing system described here as a feature that supplements its conventional car rental business.

Using this car sharing system, private car owners can earn money at times when they are not using their cars. Borrowers can rent cars at rates that can be lower than renting from car rental companies and can provide income to private owners who may be their neighbors or friends. Borrowers can rent cars from a very wide variety of locations, including locations (such as in their neighborhoods) that are more convenient to the borrower than commercial car rental locations. A wide variety of cars may be available for rent. Uses of the car sharing system can reduce the number of vehicles on the road, helping the environment and reducing traffic.

There is no limit to the neighborhoods, towns, villages, suburbs, cities, or countries (or the physical locations within any of those) in which assets covered by the system can be located nor the relationship between owners and borrowers and the places where the assets are located at a given time.

A typical use of the system would be by an owner in a neighborhood who normally keeps her car parked in her driveway and a borrower who lives in the same neighborhood, does not own a car, and who needs to use a car from time to time. In a different example, suppose Mary will be traveling from her home in Cambridge to a hotel in Palo Alto and wants to share a car in Palo Alto on Saturday morning. Suppose also that Bill, who lives in Dallas but has driven his Toyota Prius to Palo Alto for the week and does not expect to need to use it on Saturday, is willing to lend it to her. The car sharing system can provide a platform that enables Bill to post this offer, and for Mary to reserve and then use the Prius on Saturday in Palo Alto.

As mentioned, in some implementations, there is a neighborhood aspect to the use of the car sharing system. For example, a large number of car owners in New Haven who are willing to share their cars can make them available through the system. Because of the number of cars made available in such a virtual fleet, people who live in New Haven and want to use cars can use the system with some confidence that they will be able to find cars nearby at times when they need them.

In this respect, for some implementations, there is a concept of a home location for an asset, for example, the place where the owner of the asset normally keeps it stored and available for his own use. In many situations, the owner of an asset that is to be offered in the sharing system will continue to want to use it often and make it available for sharing only at certain times and during certain periods. The owner will want the car to be picked up by the borrower at the home location at the beginning of the sharing period and dropped off at the home location at the end of the sharing period. The home location could be the owner's driveway. The system, of course, can be operated and be useful in modes in which there is no strict home location for assets (and we describe such implementations later). Assets can also have more than one home location, such as an owner's home and an owner's workplace. Thus, in some implementations, there need not be a single home location or even any specific home location.

In some implementations, as shown in the street map 102 of an example urban neighborhood 103 in FIG. 1, many people in the neighborhood own cars and store them in their garages or driveways. There are also people in the neighborhood who do not own cars (or enough cars) and would like to borrow cars now and then. (Note that a given person can at times be a lender of a car that she owns and at other times a borrower of a car owned by someone else. An owner can even be a borrower of her own car.) The system 104 described here provides a platform to enable and manage car sharing in the neighborhood.

In the neighborhood 103, for example, car owners, such as Albert 106 lives in the house 101 on Princeton Street) and Barbara 110, who lives in the third floor apartment 99 on Berkeley Street, can offer their cars 108, 112 for sharing transactions using the car sharing system. In this example, the home locations of the cars can be the driveways or garages associated with the places where the car owners live.

In some implementations, the system includes an online site 105 (e.g., a website) provided from a server system 107. Car owners can register for participation, enroll their cars as available for sharing, enter into planned sharing transactions, and manage those transactions, among other things. Borrowers can register for participation, identify cars that are available, enter into planned sharing transactions, and manage those transactions, among other things.

We use the term “online site” broadly to include, for example, any facility that is accessible through an electronic network such as a website, a webpage, pages or screens that can be viewed on mobile devices, and any other kind of facility that enables a user to interact electronically to provide and receive information associated with the car sharing system. We use the term “server system” broadly to include, for example, one or more computers connected to the electronic network that store, maintain, and provide resources associated with the car sharing system.

Returning to the example of FIG. 1, also living in neighborhood 103 are potential car borrowers, such as Carol 114 and Deirdre 116, who are interested in using cars that have home locations that are near where they live, such as the cars of car owners who have enrolled their cars on the system 104. As mentioned, car borrowers can register at the online site and use it to view information about available cars. The information can include the home location of the car, its make, age, mileage, color, times when the car is available, and a wide variety of other information associated with the car sharing system. We use the term “home location” broadly to include, for example, the place or the vicinity of the place where the asset is typically kept by the owner for the owner's use or by the owner for the purpose of engaging in sharing transactions. Home location also includes any other location that can be identified as the place where the car is located at a given time. The home location can be a dynamic location and need not be associated with or near to where the owner is located.

Only one neighborhood is shown in FIG. 1, but the system is capable of and useful in managing car sharing for dozens or hundreds or thousands of such neighborhoods (and villages, towns, cities, states, countries, and other regions) all over the world, neighborhoods that can be disconnected or overlapping.

Referring also to FIG. 2, in some implementations, the platform offered to owners and borrowers by the system can include electronic devices 208 for the cars 206 that allow the system to provide and receive information from the cars 206 to initiate, manage, and complete, and help owners and borrowers to initiate, manage, and complete sharing transactions. When a borrower, for example, Deirdre 116, makes a reservation for a car, for example Barbara's car 112, the server system 107 can send information to the device 208 in Barbara's car 112 to provide access to Deirdre 116. The system provides to each borrower a mechanism, such as an access card 207, that identifies the borrower to the device 208 in the car. The device 208 can unlock the car door for the borrower with the appropriate reservation, in this case Deirdre 116. The device 208 also allows Deirdre 116 to start and operate the car. Once Deirdre 116 is finished borrowing the car, Deirdre 116 returns the car to the home location for other borrowers, and also the owner, to use the car.

The system also facilitates the borrowing of cars by providing liability, property damage, collision, comprehensive, theft, and other insurance coverage for the car and the borrower underwritten by a third party insurance carrier and that automatically is in force when the borrower is driving the car. That is, in some implementations, the insurance is effective only during and with respect to individual sharing transactions during the sharing periods, and not at other times. We use the term “insurance” broadly to include for example, any instrument or device that covers at least part of the risk of loss associated with an asset or the use of the asset, based on spreading the risk of loss by covering such a risk of loss for a large number of units of the assets. In some examples, during the sharing period, a car owner's insurance may become ineffective, because the owner is using the car for a commercial purpose during those periods. The host or manager of the asset sharing system arranges for insurance that covers the car, the owner, the host or manager, and the borrower during such periods. The cost of the insurance is determined based on usage (liability coverage, for example, is billed by the mile, and physical damage coverage is billed by the hour).

Typically, insurance on a private car covers the owner's liability, collision damage, theft loss, and certain other risks. Private car insurance normally has a livery exclusion that suspends coverage while the car is being used to carry people or things for a fee. Insurance to support the operation of the system can be provided by arranging for commercial insurance for which the host or manager of the system is a named insured, the borrowers and owners of the cars are additional named insured during the sharing periods, the borrowed car is a covered vehicle, and the borrower is a covered person. In some implementations, the policy can be made the primary coverage except when the driver has insurance that will cover the risk. When a borrower is using a car during a sharing period, the car, the borrower, and the owner are automatically covered under the commercial policy if needed, without any action required by the owner, the borrower, or the host of the sharing system.

Interactions between borrowers, owners, and others with the car sharing system is, in many examples, conducted through an interactive user interface presented on a computer display, through a screen of a mobile device, at a kiosk, or in any of a wide variety of other ways that enable a user to view information and provide input. The user interface enables users to conduct essentially all business with the car sharing system so that telephone calls to the host or manager may never be required or required only infrequently. The business to be conducted can include registering as a participant, making cars available, finding cars that are available, defining the terms of sharing transactions, making and managing reservations, agreeing to planned sharing transactions, managing and completing the planned sharing transactions including in-progress sharing transactions, following up after sharing transactions, paying for the transactions, collecting fees, and a wide variety of other activities.

In some implementations, the user interface is in the form of webpages delivered from the server. Before turning to examples of website pages, we describe basic activities that a borrower and an owner can engage in as part of using the car sharing service.

As a borrower, the user provides contact information and her driver's license information when she becomes a member. The system receives information pertaining to the driving record of the borrower. The system can reject borrowers who have a poor driving history, indicated by tickets, violations, or accidents.

Once a borrower is approved (which can be done by a representative of the host or manager behind the scenes, with the result being indicated to the user by an email or some indication on the website), the borrower can reserve a car on the online site. The borrower can also reserve a car by telephone (either live or using an interactive voice response system), or by a mobile application on a mobile device, such as a smart phone. The system can display to the borrower available cars in a variety of ways, such as listing the available cars closest to the borrower's home address first. Alternatively or additionally, the listing can show the available cars that are closest to the borrower's current location, for example, if the borrower is using a smart phone or other mobile computing device that can provide current location information. The system can also provide a map view that shows all cars available in portions of a map. The map can be updated to show different locations, with corresponding updates to available cars in the different locations. The system also provides interfaces for changing and canceling existing reservations.

The system sends a confirmation email to the borrower including information regarding the reservation. The information includes the home location of the car and a description of the car. As the cars can be privately owned vehicles, the home location can be a variety of locations, including driveways, alleys, garages, parking lots, and parked on the street. Thus, the confirmation email can include a precise, current location of the vehicle. In some cases, the system assumes that the home location is always the current location for pick up, and the owner sets the home location on the system and only changes the fixed home location when a change is made in that location. In some examples, the home location can change each time a sharing period ends. In some examples, the home location can change but only within a reasonably small range in the vicinity of a fixed place. For example, the home location can be any parking space within three blocks of the owner's home. The system can send an additional email and a text message approximately 90-10 minutes before the start of a reservation, alerting the borrower of where exactly the last driver has parked the car. The cars can also have additional identifying markers, such as logos. The system can also provide a map, for example, on a mobile computing device, that can display the current position of the borrower and the location of the vehicle.

In some implementations, each car is subject to one or more vehicle condition reports, which allow borrowers to report damage on the vehicle. The vehicle condition reports can be provided and stored electronically or can be printed and stored in the car. Upon locating a reserved vehicle, the borrower can examine the car for damage, such as scratches or bumps. The borrower can compare any damage to the vehicle condition report, which can be located, for example, in the glove box, or fetched electronically onto the borrower's mobile device. If there is new damage or damage different from what is noted on the report, the borrower can add the damage to the report and also report the damage to the system before driving the car. The report can include a photograph of the damage taken using a camera on a mobile device of the user. This can help the system attribute damage to specific borrowers to hold the appropriate people accountable. Similar procedures can be used relating to the cleanliness of the car.

At the beginning of the sharing period, the borrower enters the car using her access card. A sensor is located on the car (part of the electronic device or equipment included in the car), for example, on the driver's side of the windshield, which can be indicated by a logo and text such as, “hold card here.” The sensor and access card can use radio-frequency identification (RFID) or other technology to communicate. In some implementations, the access card is a public transit card, for example, a subway pass card that the borrower already owns and uses to pay for the subway. By holding the access card to the sensor, the device located in the car unlocks the front doors. The car keys can be kept in the car, for example, to the right of the steering wheel, under the front seats, in the glove box, or in the middle armrest. In some implementations, the device requires the borrower to start the car within a threshold time period after the sensor detects the access card. If the threshold time period elapses, the device logs the borrower out, necessitating that the borrower hold the access card to the sensor again to log back in.

The borrower can then use the car during the sharing period. In some implementations, the car includes a credit card that can be used to buy gas for refueling the car. The system can penalize borrowers who return cars with fuel levels below a certain threshold, such as a quarter of the gas tank.

The system can provide an interface on the online site or on the mobile application that allows borrowers to extend their reservation. Additionally, the borrower can extend a reservation by telephone. The system can penalize borrowers who return cars later than the end of their reserved time.

Once the borrower is finished with the car at the end of the sharing period, the borrower returns the car to the home location. If the home location was a street parking spot, the system can allow for an acceptable area within a threshold distance, for example a quarter mile, of a preferred location. In other words, the return location can be different from the previously current home location. In some implementations, a map is located in the car that delineates the acceptable area. The system can penalize borrowers who park cars outside of the acceptable area. The system can also penalize borrowers for parking in certain locations, such as metered parking spots or streets scheduled for street cleaning within a threshold time. Once the borrower parks and exits the car, the borrower can log out of the system by holding the access card to the sensor. The device can then lock the doors of the car. In some implementations, the system provides refunds for cars returned earlier than the scheduled ending time of the reservation.

In some implementations, if a reserved car is unusable, such as out of fuel, damaged, or in unscheduled use, the system can find another available car for the borrower. If the home location of the replacement car is distant from the home location of the unusable car, the system can also provide a refund for a taxi fare.

In some implementations, if a borrower gets into a minor accident (e.g. a scrape or minor dent) and can continue safely driving, the system can provide an incentive for the borrower to report the damage. For example, the system can reduce a deductible payment that will be charged by an insurance company. The system can also provide for towing in the event of a car breaking down or being rendered immobile by an accident.

The system provides insurance that automatically covers approved borrowers. The insurance can, for example, have a combined limit for liability, bodily injury (of others), theft, collision, and property damage of $1,000,000 per event. In some implementations, the borrower is held responsible for the first $500 of expenses in any at-fault accident, like a standard insurance deductible. If the borrower has personal auto insurance, the personal auto insurance is used as primary insurance coverage during the reservation. In some implementations, the system provides a reduced deductible or no deductible for an annual fee. In some implementations, borrowers under an age threshold are required to have their own insurance policy with a threshold coverage limit. The insurance is provided by a third party insurer. Under the insurance arrangement, coverage of a borrower and the car as used by the borrower is applied automatically for each sharing transaction during the sharing period.

In some implementations, the system bills borrowers through a debit or credit card associated with their membership. Borrowers are provided estimates of the rental cost for a reservation, but are billed after the borrower completes the reservation. The actual amount billed may vary depending on such things as penalties or early return of the car. The system provides an interface to view past invoices online. In the event of non-payment, borrowers are contacted to update their account. In the interim, the account is suspended until payment issues are resolved. The system can also charge an additional penalty and if necessary use a third party collection agency. The system can also provide for prepayment, for example, by purchasing credit beforehand.

In some implementations, reservations have a minimum time length, such as one hour. After the minimum reservation length, reservations can be lengthened by increments, such as fifteen minutes. Borrowers can be charged for reservations regardless of whether they actually use the cars. The system can also provide daily rates, and activate the daily rates when the hourly rates for the number of hours selected would exceed the designated daily rate. The daily rate is good for 24 hours.

In some implementations, the reservations include driving mileage limits. For example, every hour of reserved time can include 20 miles of driving. For daily rates, the mileage limit can be a different, fixed amount, such as 160 miles. Borrowers can be charged at a rate, such as forty cents per mile, for each mile beyond the limit. In some implementations, the mileage rate varies with the rental rate. For example, each mile can be charged at a higher rate for cars that charge more per hour to rent.

The system can require borrowers to notify the system of any changes in driving record. Failure to do so can result in termination of membership.

We now describe how the system can be used by a car owner, to offer his car for sharing. First, the user also becomes a member of the system on the online site. In some implementations, the car provided for borrowing has to meet certain criteria, such as age of the car, mileage on the car, and the functionality of the car. For example, the car can be required to be no more than eight years old and have been driven fewer than 85,000 miles. Further, cars can be required to be safe, well maintained, and fully functional. Once approved, the device that communicates with the server system and provides access to borrowers is installed in the car.

The owner then sets times for the car to be available to rent. To set a schedule, the owner goes to the online site and logs in to an owner page. Once there, the owner can set which times the owner wants to be able to use the car, and what times the owner wants open for borrower reservations. The owner page can also show both upcoming and previous reservations that members have made. The owner also receives notification emails indicating when the owner's car has been reserved. The owner can also reserve his own car in times set as available for borrowing if the owner wants to use the car or if the car is unavailable for borrowing.

In some implementations, the owner sets the price of the rental of the car. The owner can set a per hour amount, which can be based on factors such as make, model, and year of the car. In some implementations, the cost of fuel (charged on a credit card in the car) is deducted from profits given to the owner. Insurance and other costs can also be deducted prior to paying the owner. The owner also provides the home location of the car, such as a driveway or parking lot space. The location can also be a street parking space, in which case the owner provides a home location and an acceptable area for parking that is within a threshold distance from the home location. The owner can be penalized if the car is not in the home location or for factors such as accessibility and safety of the home location. The owner can also be penalized for maintenance and cleanliness issues with the car. In some implementations, a portion of penalties assessed to borrowers can be given to the owner of the car.

The system also provides pages on the online site where members can write reviews of cars and borrowers. The reviews can be displayed with the car when a borrower is looking for a car to borrow.

The system also provides pages on the online site for community ambassadors. A community ambassador is, for example, a member who can work with the system to bring car sharing to locations where the car sharing system does not currently operate.

The community ambassadors can carry out tasks such as conducting research to gauge interest in the new location, collect initial contact information of interested people, and tell people in the new location about the car sharing system. The car sharing system can help the community ambassadors by providing marketing materials and provide incentives such as a portion of the profits from the new location for a certain time period or other incentives.

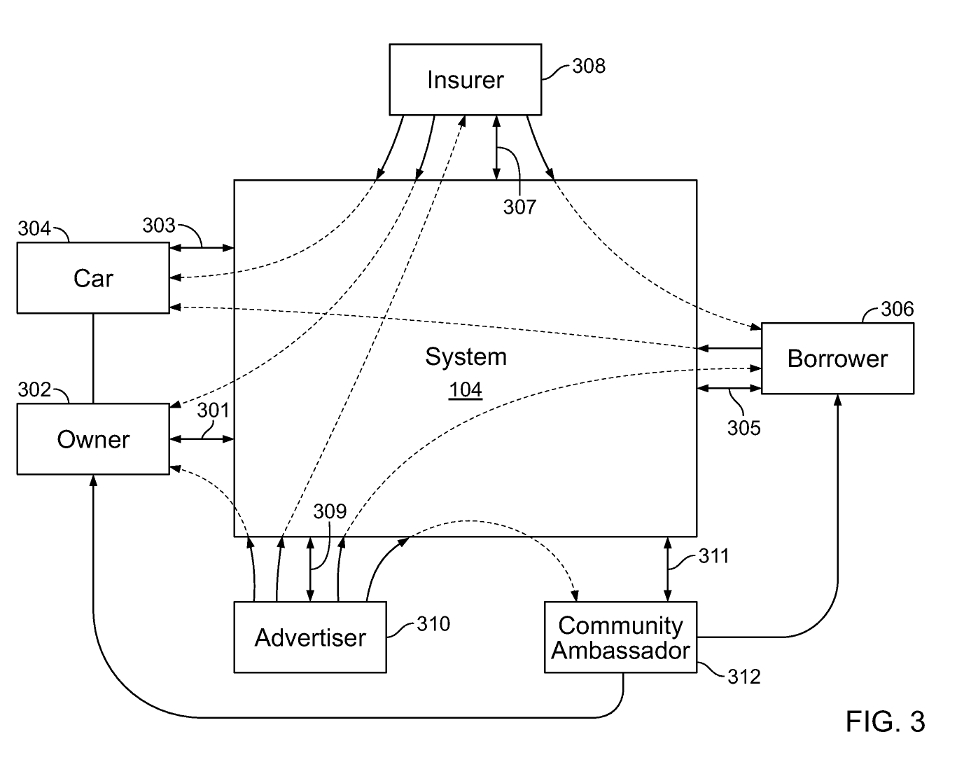

FIG. 3 illustrates, for some implementations, the parties who are involved in using and operating the system, and their relationships in connection with sharing transactions through the system 104. As described above, the system 104 interacts 301 with the owners 302 to receive information regarding the owners' cars 304 and also to pay the owners. The system 104 communicates 303 with the owners' cars 304 to determine the cars' locations and also to authorize 305 borrowers' 306 use of the cars 304. Borrowers 306 interact 305 with the system 104 to reserve and borrow cars 304 and also to pay for the rentals. Insurers 308 interact 307 with the system 104 to provide insurance coverage for the sharing transactions, covering the borrowers 306, owners 302, and cars 304 while the cars are being used through the system 104. Advertisers 310 can interact 309 with the system 104 to provide advertisements on the online site, which is viewed by owners 302, borrowers 306, insurers 308, and community ambassadors 312. Community ambassadors 312 interact 311 with the system 104 to receive help in reaching out to borrowers 306 and owners 302 in their communities.

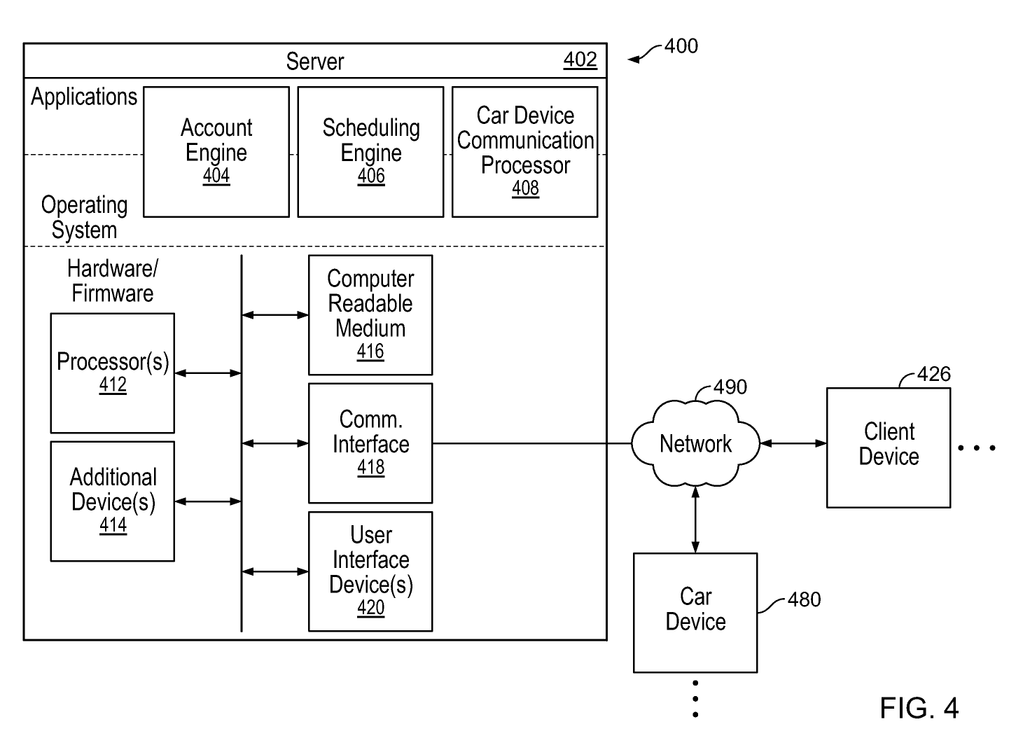

FIG. 4 illustrates an example software architecture 400 of the system. In some implementations, the system includes of a server 402, a large number of user devices 426, and a large number of car devices 480. The server 402, the user devices 426, and the car devices 480 are connected through a network 490, e.g., the Internet (or in some respects a mobile telephone network or any other electronic communication network). While only one user device 426 and one car device 480 are shown in FIG. 4, multiple user devices and multiple car devices can be connected to the server 402 through the network 490. The server 402 is a data processing device, for example, a computer or a farm of computers in one located or distributed locations.

The server 402 includes modules, e.g., executable software programs, including an account engine 404, a scheduling engine 406, and a car device communication processor 408. The account engine 404 processes requests from a user, for example, as described above in reference to opening and using accounts on the system. The scheduling engine 406 processes schedules provided by owners and borrowers to coordinate the sharing transactions, for example, as described above. The car device communication processor 408 provides and receives information from the car devices, for example, regarding locations of cars and authorized borrowers of cars. The server 402 can also have hardware or firmware devices including one or more processors 412, one or more additional devices 414, computer readable medium 416, and one or more user interface devices 420. Examples of user interface devices 420 include a display, a camera, a speaker, a microphone, a tactile feedback device, a keyboard, and a mouse.

In some implementations, the server 402 stores resources, such as web pages and user account information. In some implementations, some or all of the resources are stored on a computer readable medium 416. In some implementations, some or all of the resources are stored on one or more additional devices 414, for example, a hard drive.

The server 402 uses its communication interface 418 to communicate with the user devices 426, the car devices 480 and other devices through the network 490. For example, the server 402 can receive requests to borrow cars through its communication interface 418, and can provide information regarding available cars through its communication interface 418.

The user devices 426 are connected to the server 402 through the network 490. The user devices 426 are any kind of mobile or non-mobile communicating and processing devices such as mobile telephones, pads, and notebooks. A user can use a user device 426 to request web pages from the server 402, for example, through a web browser running on the user device 426. The user can also use the user device 426 to view web pages provided in response to the requests, and submit further requests, for example, through a web browser.

Each car device 480 is connected to the server 402 through the network 490. The network 490 can also include cellular data networks through which the car device 480 and the user device 426 can communicate with the server 402.

We now describe screen shots of webpages for an example implementation of the platform of the car sharing system.

FIG. 5 is an example home page 500 for the online site. In some implementations, the home page 500 displays a logo 502 in the upper left corner of the page 500. The logo 502 can be a hyperlink that links to the home page 500. The logo 502 is present in a similar location on other pages of the online site, providing an easy way to return to the home page 500 from any page on the online site. In some implementations the service provided through the website could be private labeled and associated with a business for which the car sharing is only a secondary activity.

The home page 502 provides a menu 504 next to the logo 502. The menu 504 can include links 506, 508, 510, 512 to other pages on the online site. The pages that are linked from the menu 504 can be pages that are frequently accessed or contain information that provide overviews of different subjects on the online site. For example, the menu 504 can include a link 506 to a page (shown later) where a user can join to become a member of the car sharing system. The menu can also provide a link 508 to information for borrowers and a link 510 to information for car owners. The menu 504 can also provide a link 512 to information regarding a community where the car sharing system is operating. The links 506, 508, 510, 512 can be represented by a word or phrase that summarizes the information provided on the page to which the links direct. The links 506, 508, 510, 512 can also provide submenus, for example, that appear when a user places a cursor over the link.

The home page 500 provides a login box 514 above the menu 504 where a member of the site can log in. The login box 514 includes text entry boxes for a member to input the member's username and password. The login box 514 also allows the member to indicate whether the member is a borrower or an owner, for example, using a radio button or dropdown selector. By logging in, the user can be taken to a page of the online site that is specific to members, such as an owner page or a borrower page. The home page 500 also includes a location selection link 516 at the top of the page above the logo where the user can select a location, such as a city, different from the current location.

The logo 502, menu 504, login box 514, and location selection link 516 constitute a header 501 that can be included on many or all the pages of the online site. The header can also include additional links and information and can provide the user easy access to the information and the linked pages in a consistent location from anywhere on the online site.

The home page 502 includes a video 518 that introduces the car sharing system. The video 518 plays on the home page 502 when a user clicks on the video 518. The video can also play a small beginning portion of the video 518 when the home page 502 first loads. The beginning portion of the video 518 can be silent so that there is no audio when the home page 502 loads. The beginning portion can also be skipped when the video 518 is clicked on to view the remainder of the video 518 so the user does not have to watch the same portion twice. Alternatively, a separate graphic or graphic with motion can load in the space for the video 518 indicating the video 518 can be played by clicking on the video 518.

The home page 502 also includes introductory text 520 that describes the car sharing system. The introductory text 520 can includes links to other pages that provide additional information.

Below the video 518 and introductory text 520 is a section 522 that includes icons 524, 526, 528 that explain how a potential user can borrow a car. The icons 524, 5246, 528 can include pictures or graphical icons that provide a brief step-by-step process to borrowing a car. For example, the process can involve three steps, join, reserve, and drive, depicted by three icons 524, 526, 528. The icons 524, 526, 528 can include subtexts that further describe the step involved. Each icon 524, 526, 528 can also include a link 525, 527, 529 that a user can click on to receive more information about the corresponding step.

The section 522 can also include a tab 532 that provides corresponding step-by-step icons for car owners to lend a car. The section 522 can display the icons pertaining to owners upon the clicking of the tab 532. The section 522 also includes a button 530 that links to a membership signup page. The section 522 can also include another button 531 that explains the advantages of the system to existing car sharing systems and why a user would want to become a member of the system, even if they are already currently members of another car sharing system.

Another section 534 located below section 522 that includes links for people who want to bring the car sharing to a location that is not currently serviced by the car sharing system. Such locations can include neighboring cities, towns or suburbs of currently serviced locations, or the locations can be separate metropolitan areas.

A section 536 is located below the section 534 that includes testimonials of current members and links to other testimonials. Another section 538 is located beside the section 536 that includes press coverage of the system. Below the two sections 536, 538 is a footer 540 that includes links to pages such as pages that provide information regarding a company that hosts or manages the system, information on how to join the company that hosts or manages the system, links that allow people to tell others about the system through social media networks, and other links and information. The footer 540 can be included in many or all of the pages of the online site to provide easy access to the information and links included in the footer 540.

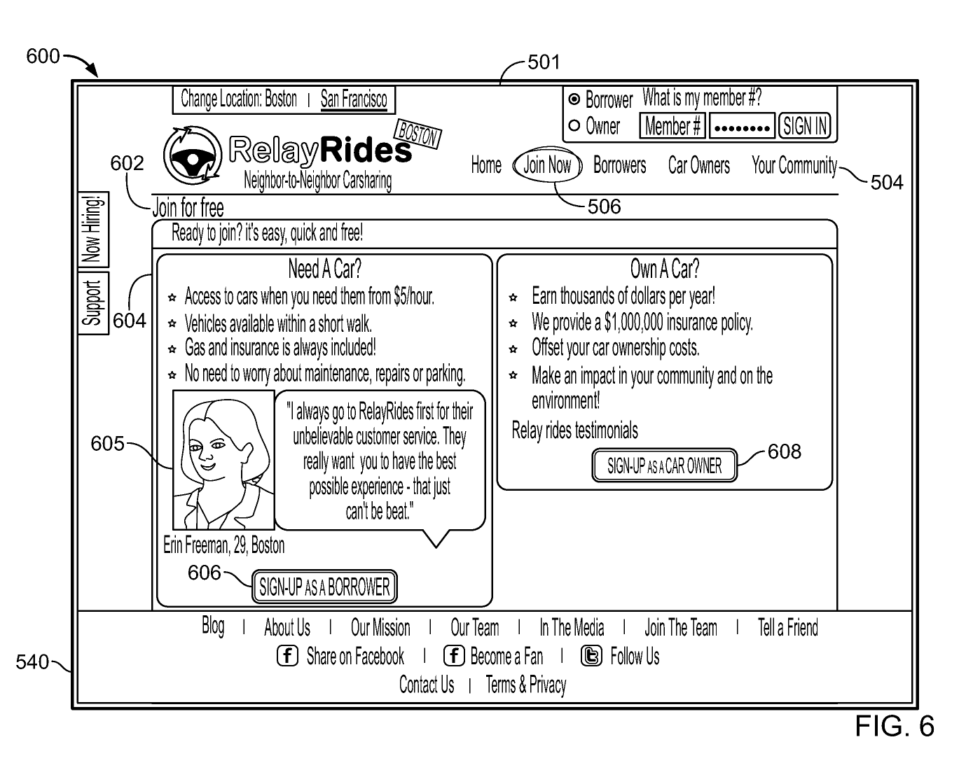

FIG. 6 shows the signup overview page 600. The signup overview page 600 can be linked from a “Join Now” link 506 in the menu 504. The signup overview page 600 includes the header 501 and footer 540. The header 501 includes the menu 504, which can be modified to reflect the section the displayed page belongs to. For example, the signup overview page 600 can include the menu 504 with a circle or some other indicator on the “Join Now” link 506 that indicates the signup overview page 600 is a part of the “Join Now” section.

The signup overview page 600 includes a title 602, for example “Join for free.” Each page or a portion of the pages can include titles that inform the user the content of the page displayed. The signup overview page 600 provides information in a main section 604 including advantages of becoming a member as either a borrower or an owner. The advantages can include testimonial text or videos, for example, next to a picture of an example borrower 605 or owner. The main section 604 also includes links 606, 608 that direct users to signup pages where users can create accounts to become members of the car sharing system.

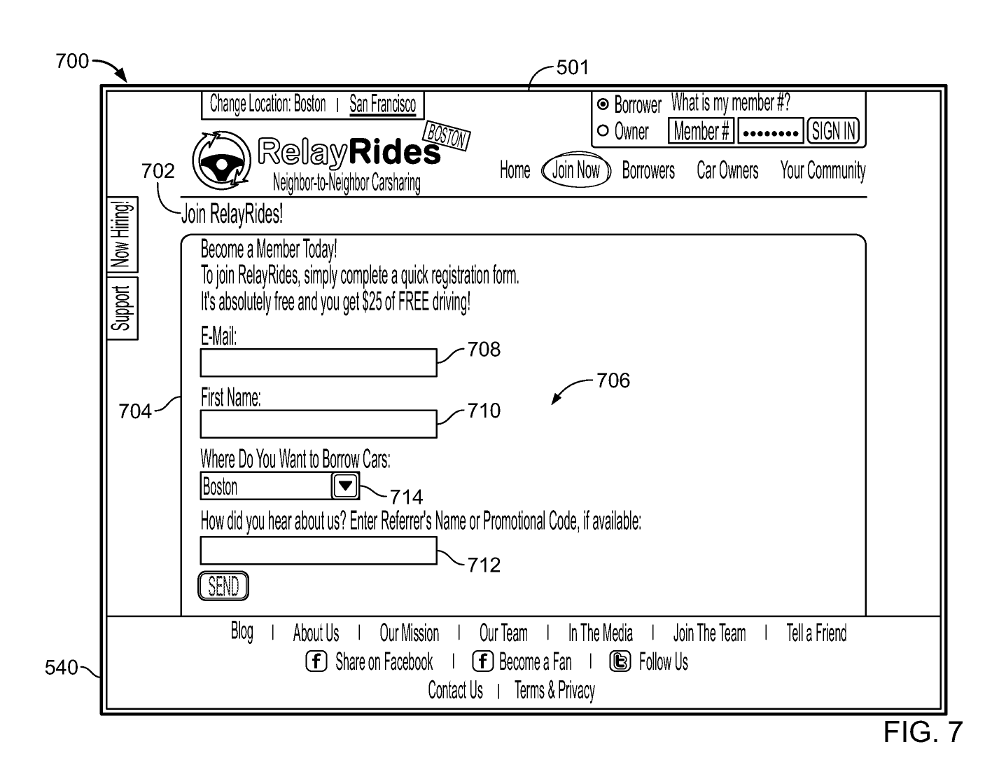

FIG. 7 shows a borrower signup page 700 where people can become members of the site as a car borrower. The borrower signup page 700 includes the header 501 and footer 540 and a title 702. In the example online site, the pages generally include the header 501, footer 540 and a title. The borrower signup page 700 includes a main section 704 with a form 706 where the user can open an account to become a member. The form 706 can include text input boxes 708, 710, 712 to provide information such as names, contact information, and information pertaining to how the user heard about the system. The form 706 also includes a dropdown selection box where the user can indicate the location or city where the user wants to borrow cars. The form 706 can be short to encourage users to sign up as members. Additional information, such as driver's license information can be received by contacting the user through the contact information provided, or by linking to another page that asks the user for additional information.

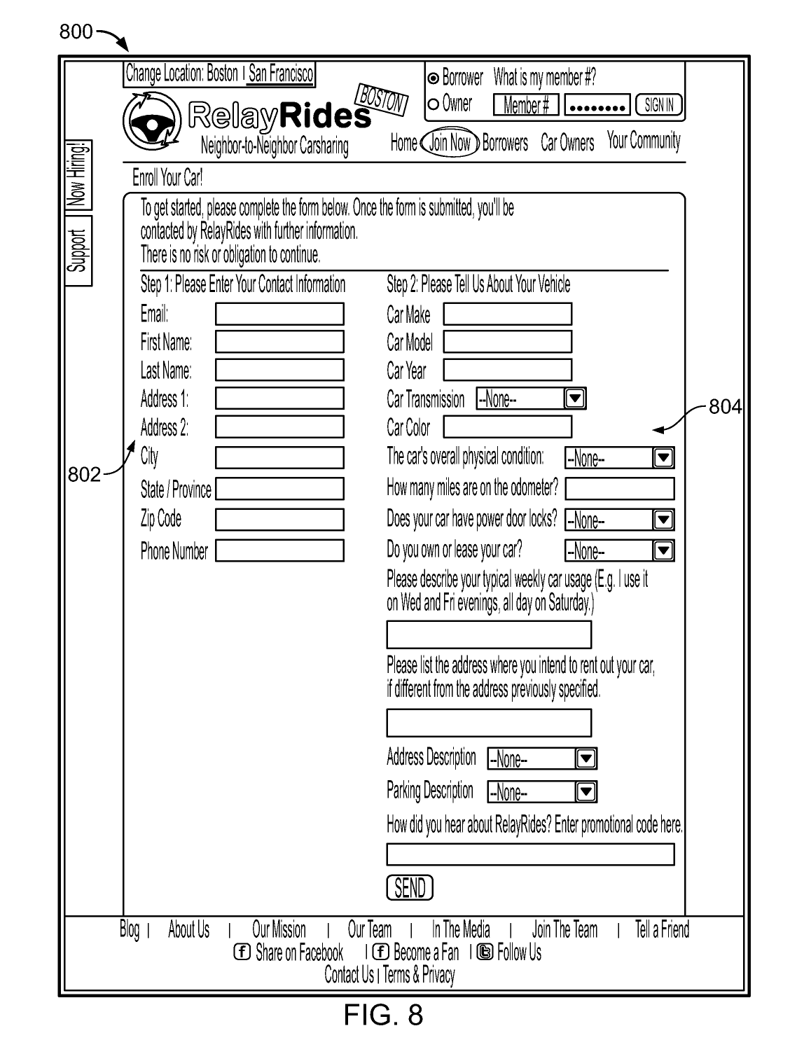

FIG. 8 is an owner signup page 800. The owner signup page 800 can be similar to the borrower signup page with different text input boxes and questions. The owner signup page 800 includes a form 802 requesting information regarding the owner. The information can include the owner's name and contact information. The owner signup page 800 also includes a form 804 requesting information regarding the car the owner is enrolling to the system for borrowing. The car information can include make, model, year, transmission type, miles driven, and other information pertaining to the car. The information can also include usage patterns of the car by the owner or potential times the owner can make the car available for borrowing. The information can also pertain to the home location of the car.

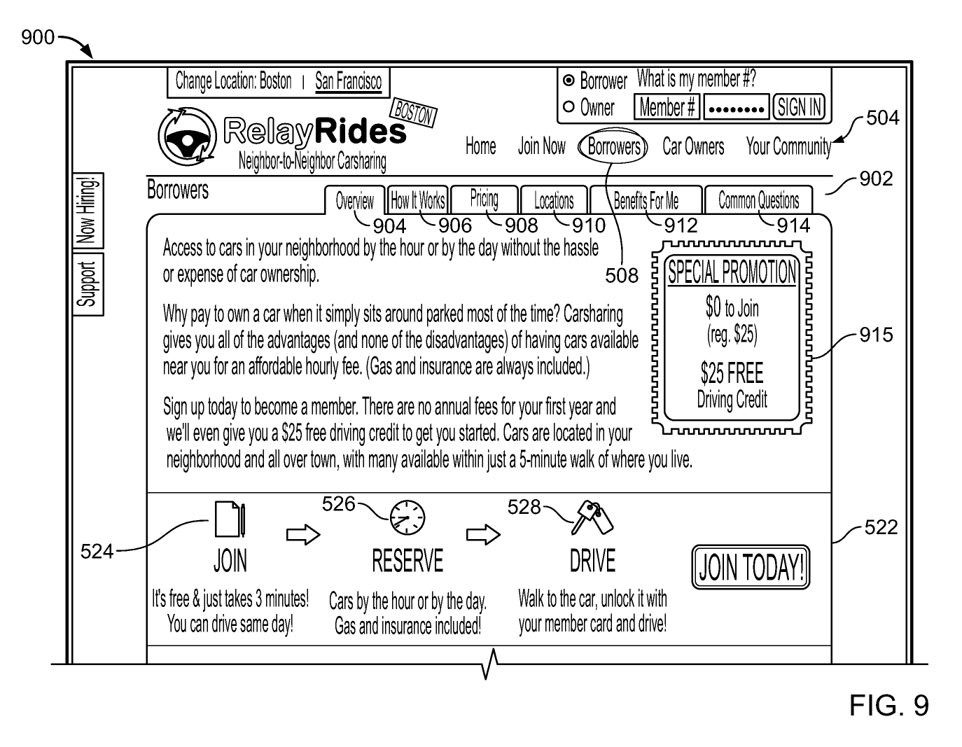

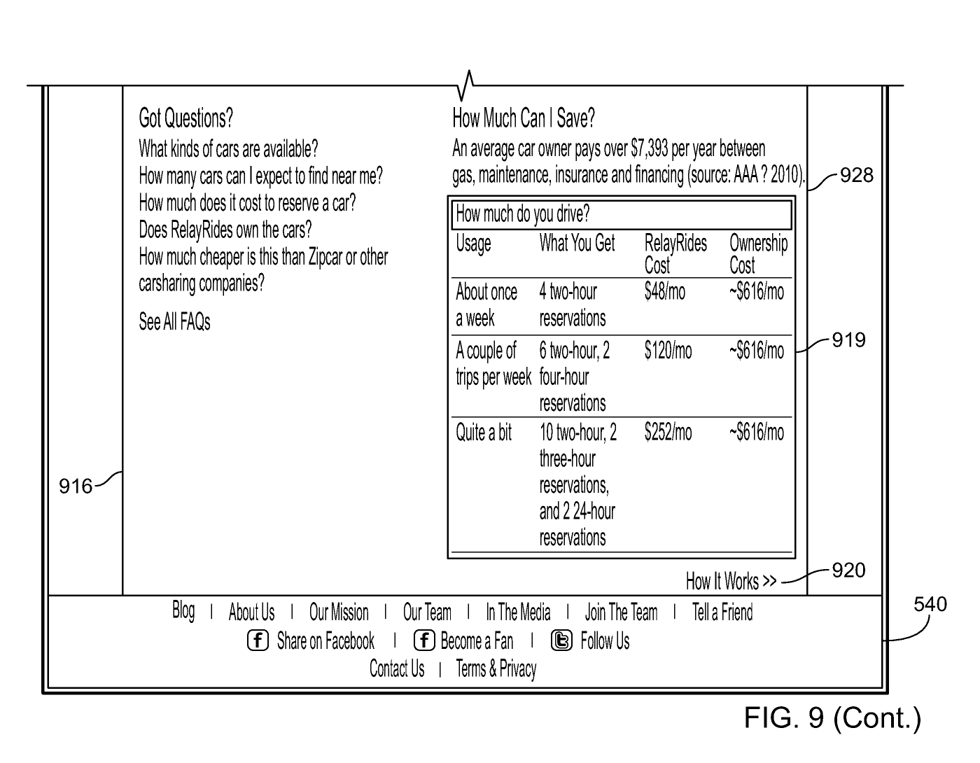

FIGS. 9, 10, and 11 show pages of the online site providing information to car borrowers. FIG. 9 is an overview page 900 for borrowers. The borrower pages 900, 1000 and 1100 include a submenu 902, displayed as tabs below the menu 504. The submenu tabs 904, 906, 908, 910, 912, 914 can correspond to the submenu headings that are displayed when a user places a curser over the “Borrowers” link 508 of the menu 504. Similar to the menu 504, the submenu 902 can be displayed in each page with an indication of which of the pages is currently being displayed.

The borrower overview page 900 includes the section 522 with the icons 524, 526, 528 providing the step-by-step process to borrowing a car. Below the section 522 is a section 916 with frequently asked questions for borrowers. The questions displayed can be a subset of frequently asked questions, such as the most popularly asked questions. The question section 916 can link to a page including more questions, which can also be accessed by a common questions tab 914 in the submenu 902. Next to the question section 916 is a section 918 that provides more reasons for a user to become a borrower. For example, the section 918 can include a chart 919 detailing an exemplary amount of money that can be saved by using the system compared to owning a car. The borrower overview page 900 can also include an icon 915 highlighting a special promotion to users for signing up as borrowers, allowing users to save money, for example, on a signup fee or a credit to use on the system.

The borrower page 900 includes links, such as the link 920 located above the footer 540 of the borrower overview page 900 that allows the user to navigate to the other borrower pages. The link 920 can correspond to the previous and next tabs of the submenu 902.

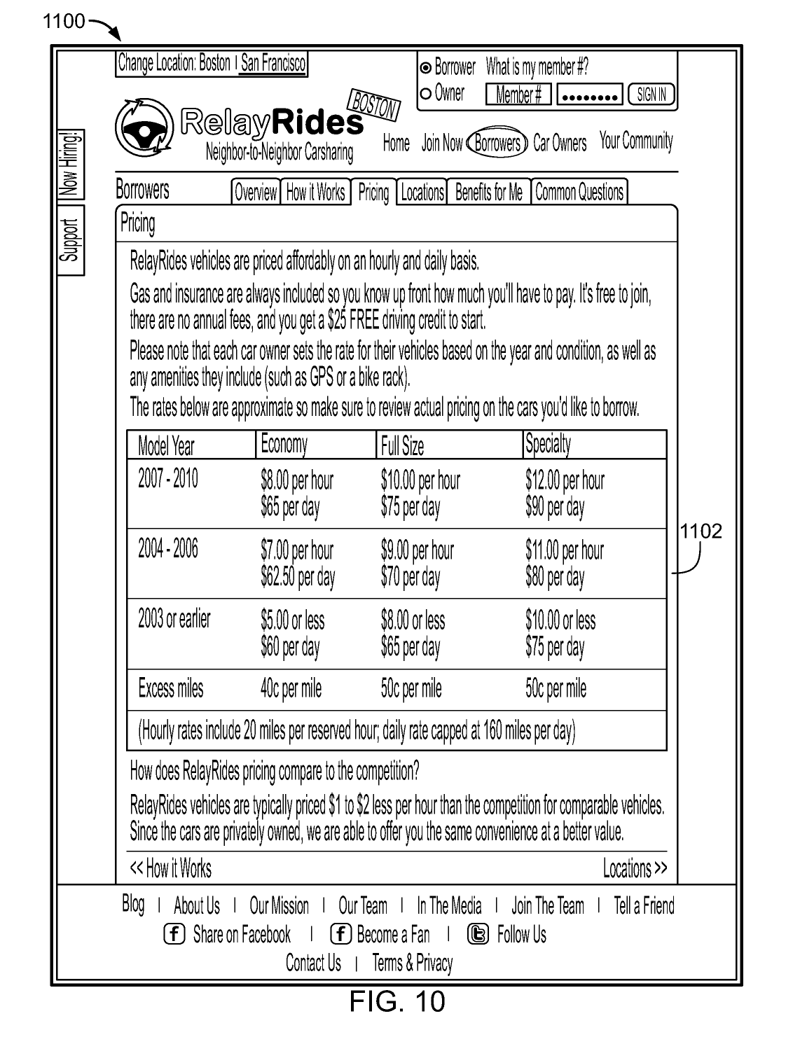

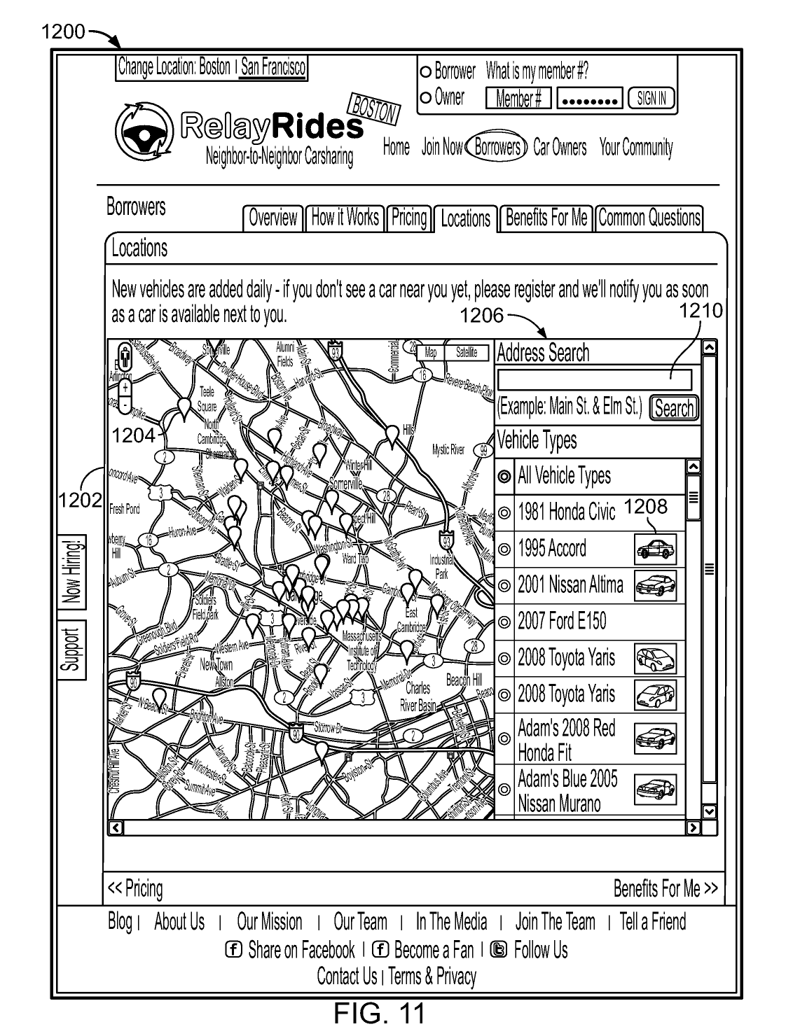

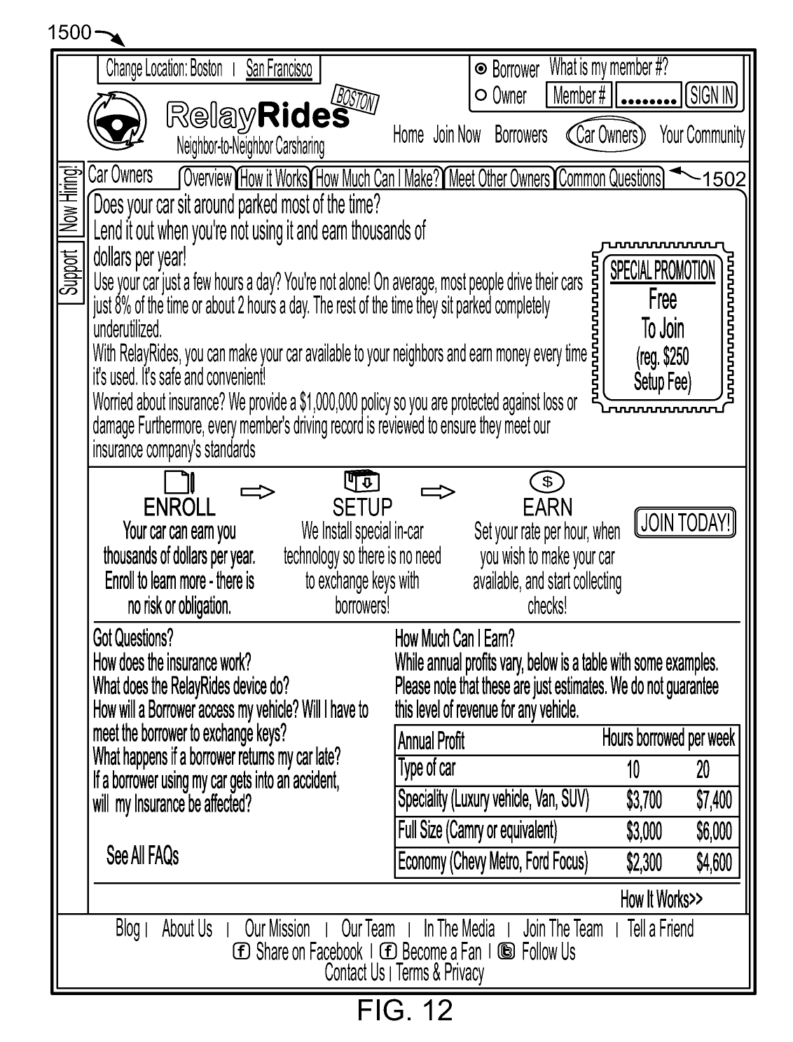

FIGS. 10 and 11 provide other information for borrowers. FIG. 10 shows a page 1100 with pricing information displayed in a chart 1102. FIG. 12 shows a page 1200 with a map 1202 with markers 1204 indicating locations where cars can be borrowed and including a corresponding column 1206 with entries 1208 displaying information about the car available at each marked location. The map 1202 also can include a search box 1210 that allows a user to enter a different location, which can direct the system to show an updated map with current available cars. The page 1200, map 1202 and entries 1208 can show actual cars currently available to members or an example scenario.

Other pages, not shown, can provide other information for borrowers, including the step-by-step process of borrowing a car referred to by the section 522 on the home page 500 and the borrower overview page 900. Another page can explain additional advantages for borrowers using the system, including questions that are commonly asked by borrowers and potential borrowers, with answers.

FIG. 12 shows a page of the online site providing information to car owners. The organization and layout of the page can be similar to the corresponding pages for car borrowers. Other pages can provide additional information, including the step-by-step process of lending a car referred to by the owner tab of section 522 on the home page 500 and the owner overview page 1500; information on how much money an example owner can make through the system; testimonials of other owners, for example through videos; and questions that are commonly asked by lenders and potential lenders, with answers.

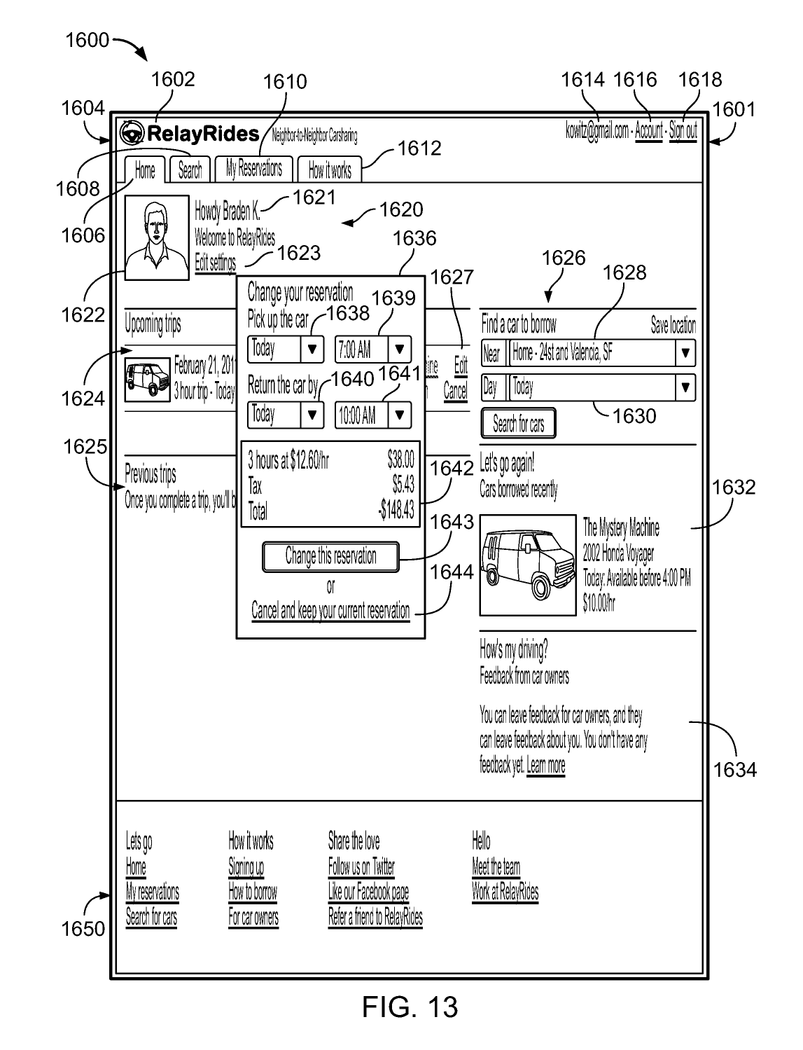

FIG. 13 is a member page 1600 that can be accessed by logging in to an account. The member page 1600, along with the other member pages, has a header 1601. The header 1601 can be similar to the header 501 of the non-member pages. For example, the header 1601 can include a logo 1602 that links to a member home page. The header 1601 includes a menu 1604 with links 1606, 1068, 1610, 1612 that link to different member pages. The menu 1604 can look like tabs across the top of the page. The header 1601 also includes a display of an email address 1614 of the member. The email address 1614 can be a login or username that the member uses to log in to the member pages. Next to the email address 1614 are links that allow the member to edit account settings 1616 and to sign out 1618.

The member page 1600 includes a member information section 1620. The member information section 1620 displays basic information about the member, including the member's name 1621 and a picture of the member 1622. The member information section 1620 can also include a welcome message and a link 1623 where the member can change account settings including display settings for the member home page 1600. In addition to the welcome message, the member information section 1620 can display member statistics, such as how many trips the member has taken and ratings or review statistics of the member.

Under the member information section 1620 is a section 1624 that displays upcoming reservations. The section 1624 displays time and car information for the reservation. The section 1624 also includes links 1627 that allow the member to edit or cancel the reservation.

When the user clicks on the link 1627 to edit the reservation, the member home page 1600 can show a popup 1636 that lets the member change the reservation. The popup 1636 includes dropdown selectors 1638, 1639, 1640, 1641 that allow the member to change the pickup and return dates and times. The dropdown selectors 1638, 1639, 1640, 1641 can default to the current reservation information. Below the dropdown selectors 1638, 1639, 1640, 1641 is a price preview box 1642 that displays the length and estimated price of the reservation as displayed by the dropdown selectors 1638, 1639, 1640, 1641. The price preview box 1642 displays estimated price information including the rental price, tax, and total estimated price. The price preview box 1642 can change as the dropdown selectors 1638, 1639, 1640, 1641 are changed to show updated estimated price information. Once the member has changed the reservation times, the member can complete the change by clicking on a button 1643. Alternatively, the member can cancel any edits by clicking on a link 1644 that cancels changes to keep the current reservation.

The member page 1600 also displays past reservations 1625, for example, below the upcoming reservation section 1624. The past reservations 1625 can include links that allow the member to provide reviews of the cars borrowed for the past reservations 1625.

The member page 1600 includes a search section 1626, where the member can find a car to borrow. The search section 1626 includes fields to input location 1628 and time 1630 for borrowing a car. The location 1628 field can default to the member's home location, or a different location the member has specified to be a default location. Alternatively or additionally, the location 1628 field can default to a current location, for example, of a mobile computing device.

Below the search section 1626 is a recent history section 1632 that displays a recently borrowed car. The recent history 1632 includes a picture of the recently borrowed car, as well as times the recently borrowed car is available for future reservations. The recent history section 1632 can include a link that leads to a reservation page for the displayed recently borrowed car. The recent history section 1632 can also display information for more than one recently borrowed car.

The member page 1600 also includes a feedback section 1634, which can display feedback by the member of borrowed cars, as well as feedback of the member from other members. For example, the feedback of the member can include feedback from owners of cars borrowed by the member. The feedback can also include feedback from other borrowers who borrowed a car after the member, including information such as the state of cleanliness of the car left by the borrower. The feedback section 1634 can also include feedback left by the member on cars or other borrowers, and include links that allow the member to provide feedback.

The member page 1600 also includes a footer 1650. The footer 1650 can be similar to the footer 540 of the non-member pages, including information and links to other pages.

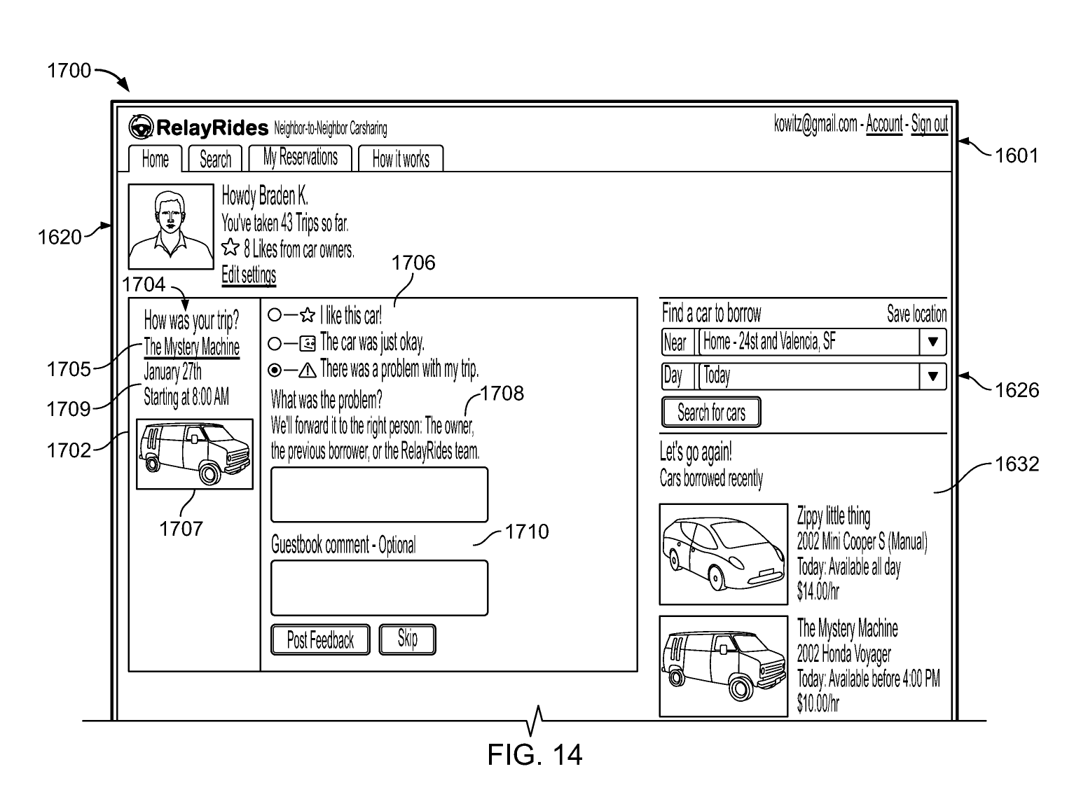

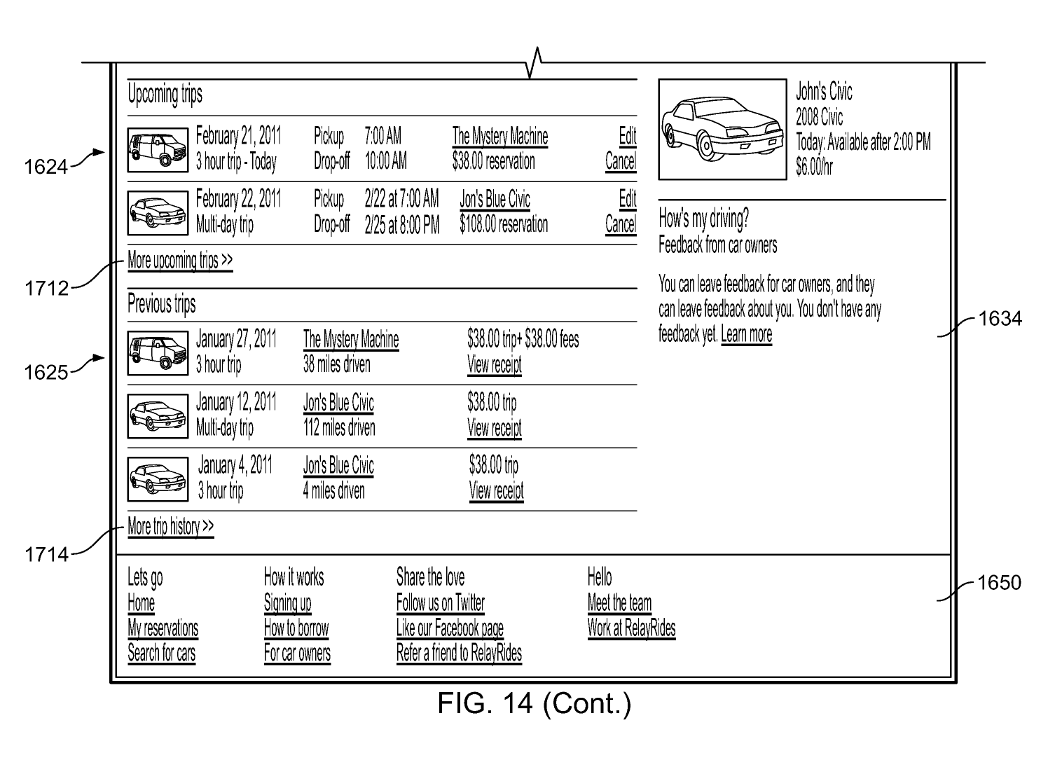

FIG. 14 shows a member feedback page 1700. The member feedback page 1700 includes the header 1601 and the member information section 1620. The member feedback page also includes the search section 1626, recent history section 1632, upcoming reservations 1624, and past reservations 1625. The upcoming reservations 1624 and past reservations 1625 can have links 1712, 1714 to display more upcoming and past reservations, respectively. The links 1712, 1714 can lead to separate pages that show more reservations, or they can update the respective sections 1624, 1625 to show more reservations in the section 1624, 1625. The member feedback page 1700 also includes the footer 1650.

The member feedback page 1700 displays a feedback form 1702 where the member can provide feedback on a borrowed car. The feedback form 1702 displays information about the borrowed car 1704, such as a name 1705 of the car, a picture 1707 of the car, and a date and time 1709 the car was borrowed by the member. The feedback form 1702 includes a radio selection option for a general rating 1706, such as good, neutral, and bad. The bad rating can be used for problems encountered with the reservation, such as unsatisfactory cleanliness or difficulty finding the car. Clicking on the bad rating button can provide a section 1708 where the member can elaborate on what the problem encountered was. The feedback form 1702 also includes an optional comment field 1710.

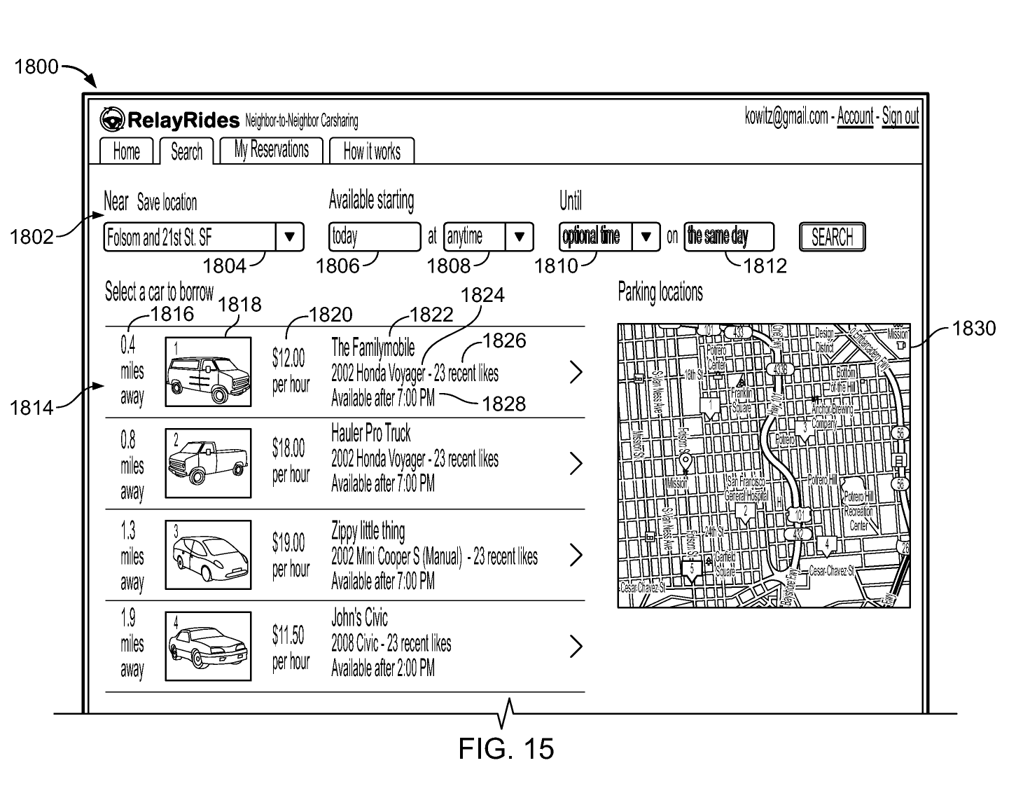

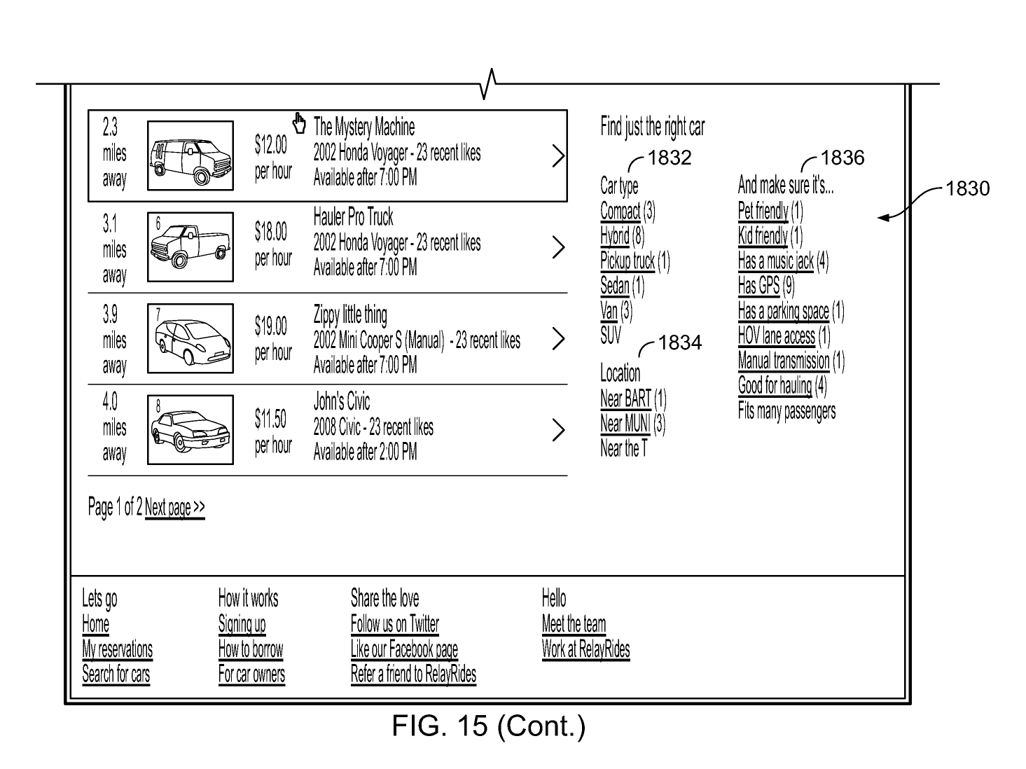

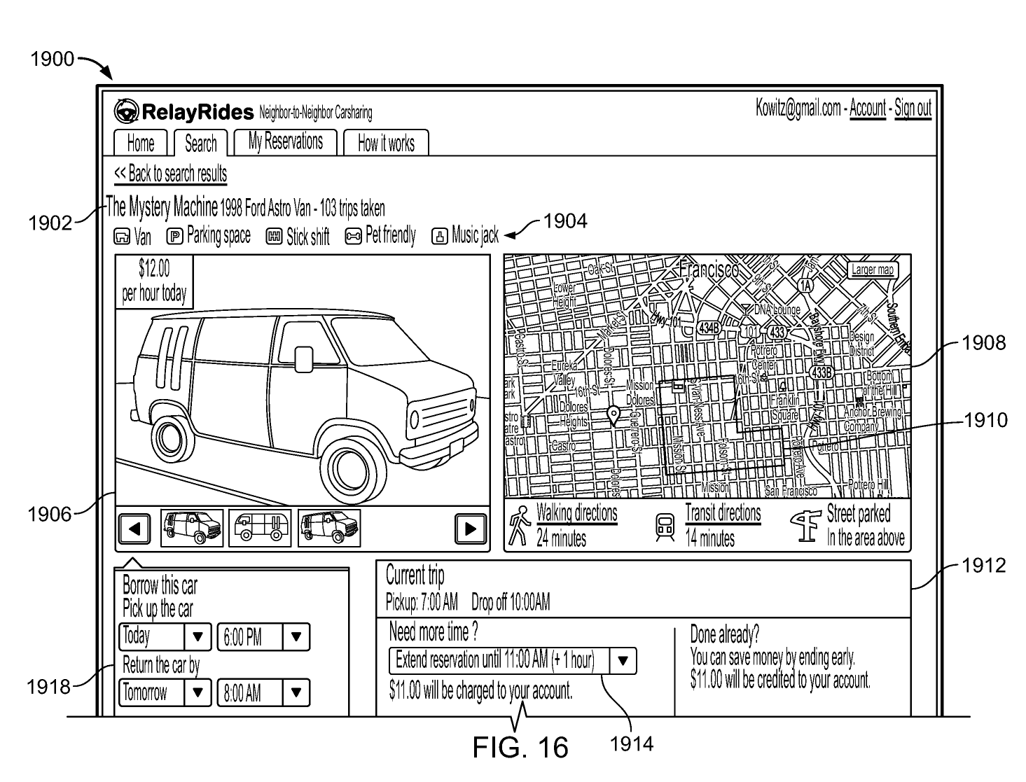

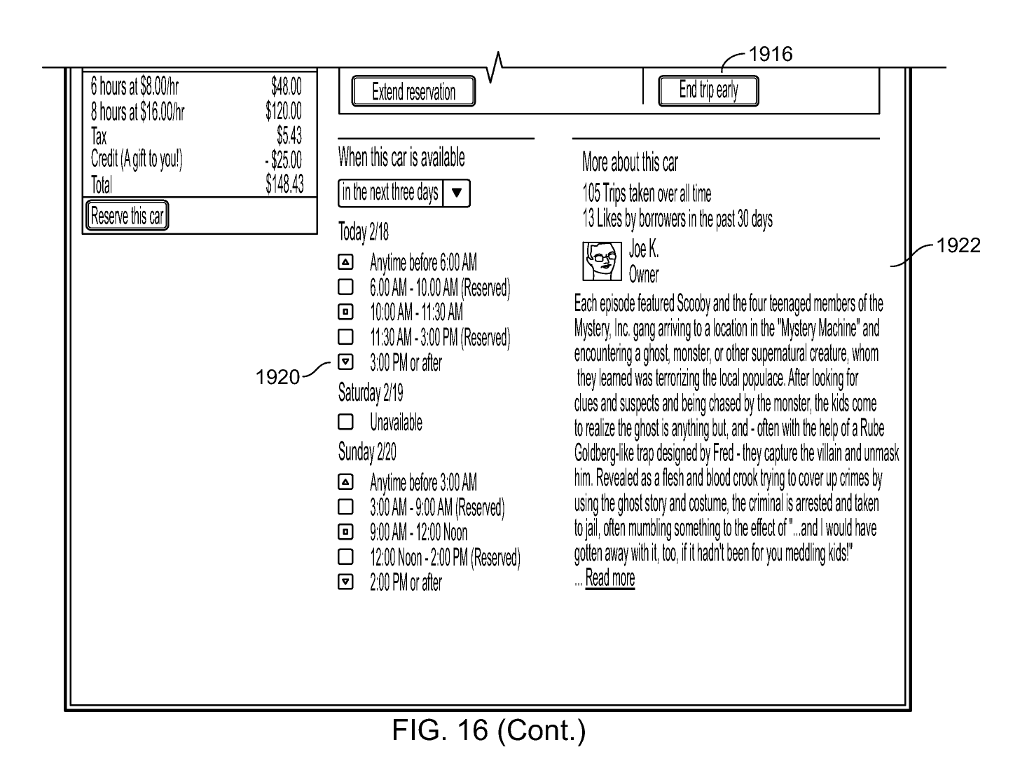

FIGS. 15 and 16 are search pages 1800, 1900 that show search results for available cars. FIG. 15 shows a listing of results 1814 for a search of cars available. The results 1814 can be returned for a search based on a location 1804, date 1806, and time 1808 that the cars are available. The search criteria are displayed in a search bar 1802 above the results 1814. The search parameters can be changed by changing the text in the input fields for location 1804, date 1806, and time 1808. The search bar 1802 also includes an optional end time 1810 and end date 1812. Entering values in the end time 1810 and end date 1812 values can narrow the search results 1814 to cars available throughout the entire desired period between the start time 1808 and end time 1810. In some implementations, the end time 1810 and end date 1812 are not optional.

Each result 1814 displays the distance 1816 from the location 1804 entered in the search parameters. The result 1814 also shows a picture 1818 of the car, a borrowing rate 1820, a name 1822 of the car, a make and model 1824 of the car, a rating 1826 of the car, and a beginning availability 1828 of the car. The name 1822 of the car can be a name for the car made up by the owner.

The search page 1800 also shows a map 1830, showing the locations of the cars returned in the search results 1814. The map 1830 also shows the location 1804 entered into the search parameter. The map 1830 can be updated, for example, by clicking on the map 1830 with a cursor or clicking and dragging on the map 1830. In some implementations, the search results 1814 are updated to correspond to the updated area shown on the map 1830.

The search page 1800 also includes a category section 1830 where the member can narrow the search results 1814 by categories. The categories can include car type 1832, location 1834, and other options 1836. The car type can include types such as compact, hybrid, pickup truck, sedan, van, SUV, and other types. The location 1834 category can include qualities of locations, such as near a subway station. The options 1836 category can include options such as pet friendly, kid friendly, has a music jack, has GPS, has a parking space, manual transmission, good for hauling, fits many passengers, and HOV access.

FIG. 16 is a search result page 1900 that shows information about a car. The car can be a search result 1814 of cars available for borrowing. The search result page 1900 includes information about the car such as the name 1902 of the car and a picture 1906 of the car. The picture 1906 of the car can include more than one picture, previews of which can be shown in smaller thumbnails below the picture 1906. The search result page 1900 includes icons 1904 that indicate features of the car. The features indicated by the icons 1904 can correspond to the options 1836 available for searching.

The search result page 1900 includes a map 1908 that shows where the car's location 1910. The location 1910 can be the home location of the car, where the car is located currently, or a location the car will at the time it is available. The location 1910 can be a specific location, such as a driveway of a house, or a more general location where the car may be parked on the street. The location 1910 illustrated in the example shows an area of several blocks, within which the car is parked on the street. The map 1908 can include directions from a current location of the member or a location searched by the member to the location 1910 of the car. The map 1908 includes links that provide directions by walking or by public transportation.

In this example, the search result page 1900 shows a car that is currently being borrowed. The search result page 1900 provides a form 1918 for future reservations and also a form 1912 for extending the current reservation. The form 1912 shows the current reserved time and provides a dropdown selector 1914 where the member can extend the current reservation, for example, in hour increments. The form 1912 can display how much more the member will be charged for the reservation extension. The form 1912 can also provide a button 1916 that allows the member to return the car early. The form 1912 can display an amount of money that can be refunded for returning the car before the scheduled reservation is completed.

The search result page 1900 also displays information in a section 1920 regarding the availability of the car. The availability section 1920 can show different time periods of availability, for example the next three days, next week, next month, or other time period. The different time periods can display the availability with different granularities. For example, a month view can show days with any availability, while a day's view can show what hours the car is available. The search result page 1900 also includes an information section 1922 about the car, such as a summary or description written by the owner of the car. The information section 1922 can also include reviews or ratings by borrowers. The information section 1922 can also include a picture of the owner.

As mentioned earlier, in some implementations, only cars for which the owners have dedicated off-street parking at known locations are accepted for car sharing. Sometimes, the system subsidizes the cost of providing the off-street parking

Here we describe in more detail an example approach to car sharing in which owners of cars to be shared can leave them in essentially any location (in other words, a dynamic home location or a vicinity around such a location), including in parking spaces on public streets. Similarly, the person who will be using the shared car can pick it up wherever the car is located at the time and when returning it In some cases, the geographical area in which the parking spaces will be located can be constrained to some defined distance from the house of the person who owns the shared car, for example, a 4-block area, and to some defined shape of area, such as a shape that corresponds to the arrangement of streets and blocks.

Among other advantages, this arrangement eliminates the need to subsidize the off street parking, and generally makes the power-sharing arrangement more flexible and convenient.

The ability to permit shared cars to be parked in and picked up at arbitrary locations, including in typical parking spaces on public streets, is made possible by appropriately configuring technology (hardware and software, for example) that is placed in the owner's (non-commercial) car. Although, in many neighborhoods, commercially registered vehicles may not be parked overnight, those limitations do not apply to private vehicles. A system of the kind described here can be built on a fleet (a virtual fleet in the sense that the cars are not all owned by one owner) of shared cars that are privately owned, without running afoul of those limitations. In any case, the car sharing host can maintain a parking policy in which the borrower is not allowed to return the car to a metered parking spot, even if it's after hours, nor to park the car anywhere there is street cleaning in the next 24 hours. In either case, if they do and the car gets a ticket or towed, it will be billed to the borrower.

In typical car sharing systems, a borrower views a list of vehicles that are available for sharing (rent) at times they need to run errands, for example, and may reserve a car many days or weeks in advance.

In a traditional system, reservations are supported up to two months in advance. In a system that uses assigned off-street parking at prearranged locations, the address at which the car is to be picked up would not change between the reservation time and the time when the car is actually used. The borrower can view the exact address before making a reservation and can expect to pick up the car at that same address at the time of his or her use.

In the system described here, of course, on-street parking cannot provide a similar guarantee of the location at which the car will actually be picked up. Because the vehicle is likely to be parked in a different space or even on a different street after each trip, the borrower must be notified shortly before his trip of the car's exact location.

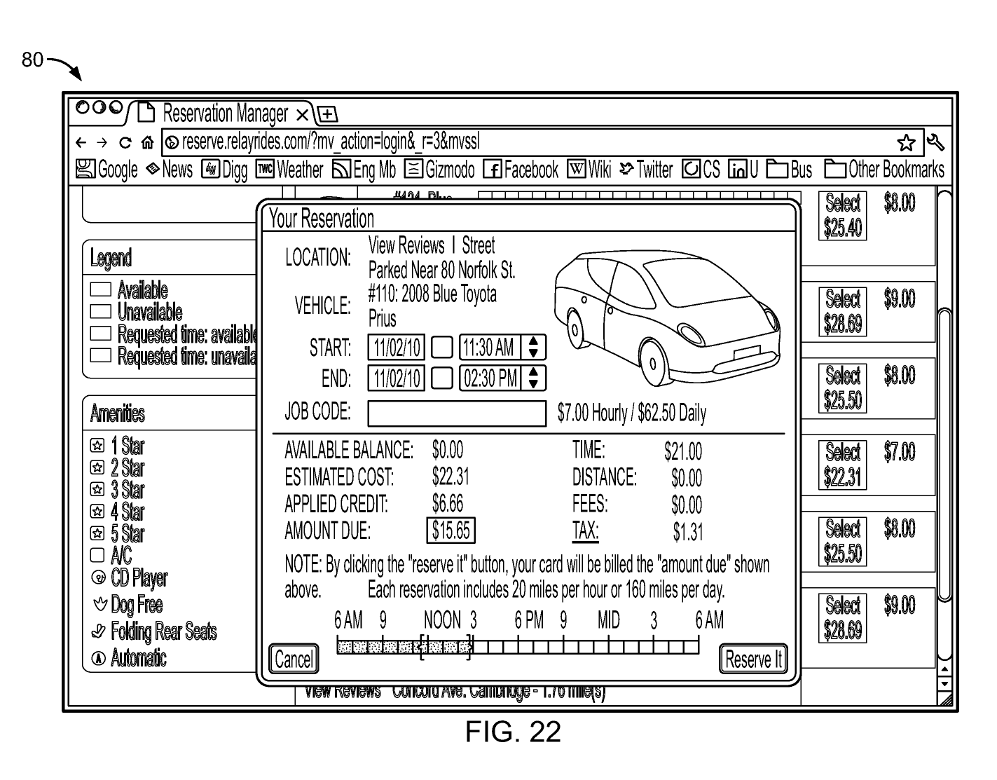

Initially, in the online, web-based reservation system 80 (illustrated in FIG. 22), when the borrower is searching for a car or is reserving one, a message is displayed telling the borrower that the vehicle is “street parked” near the “home” address of the car.

As shown in FIG. 17, each shared car has a nominal home address 10, typically the actual address of the house of the owner of the car. In some implementations, it is understood that the actual location at which the car would be picked up will be within some reasonable distance, say four blocks or some other appropriate distance measure, the home address. That is, the shared car will be within a permitted zone 12 in the vicinity of the home location. The home address and the permitted zone can be shown to the borrower (and in other uses of the system to the owner and other parties) at the time of reserving the car or at other times.

At the online site, the borrower is shown the map of the car's home address and that information is also provided in a confirmation email. FIG. 2 shows an example of a confirmation email including the location of the car 26, instructions 22 that the actual location of the car may vary modestly, and a caution 24 about how and where to return the car. The borrower is also informed by a message on the site that he will be sent an email and a text message just prior to his trip providing the car's exact location at that time. The actual location will be within the permitted zone.

In order to determine, a short time in advance of the sharing period, where the car will be at the time when the next borrower is planning to pick it up, the system needs to be aware of previous or current activity for that car. For this purpose, the system actively tracks all reservations and uses in the past, present, and future.

With respect to an upcoming rental, the system needs to know where the car will be at the reserved time. Because the car may be subject to prior rentals and therefore may be parked at any variety of locations within the permitted area at the time of an upcoming rental, the system must ask and answer a key question: “When do I know that the car will not be moved again between now and the time of the upcoming rental?” In order to determine this, the system uses a series of rules based on how the reservation system works.

The example given here is only one example. A wide variety of other approaches are used to answer the key question. Among other things, the approach being used will depend on how the reservation model works for a given system.

In the example discussed here, assume that the reservations must be for rental periods that are at least 1-hour long. Assume also, in this example that a buffer period of at least 15 minutes is required between successive reserved periods.

Therefore, one rule is that if a car is unreserved at the current time and less than 75 minutes remaining until the start of the next reservation, the system knows the car will not be rented between the current time and the start of the next reservation.

As shown in FIGS. 19, 23, and 24, a second rule is that, if the vehicle is currently being used 34 in accordance with a reservation and another reservation is coming up 32 (which is determined in a loop that includes 3 minute pauses 30), the system will calculate the time remaining until the current reservation is scheduled to end and pause until then (or perform a loop that includes 2 minute pauses 33). That is, the system does not engage in trying to figure out whether the location of the car is now fixed for the next borrower, as, obviously, it is not. When the reservation has ended 35, the system knows the car will not be moving again before the next reservation time occurs.

However, borrowers occasionally return cars late, and this circumstance is detected and handled.

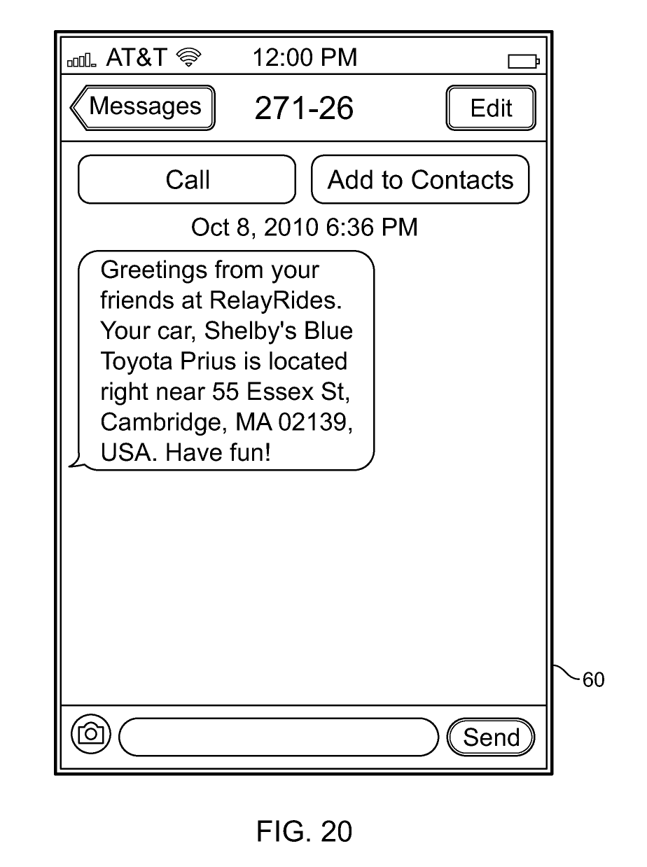

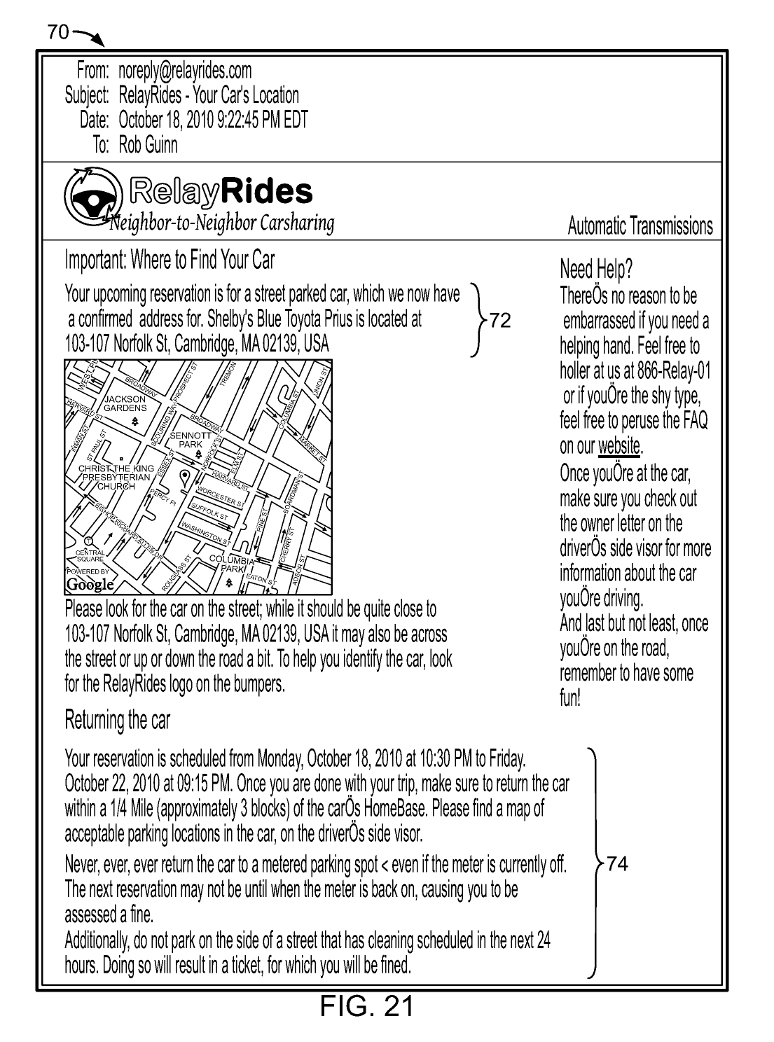

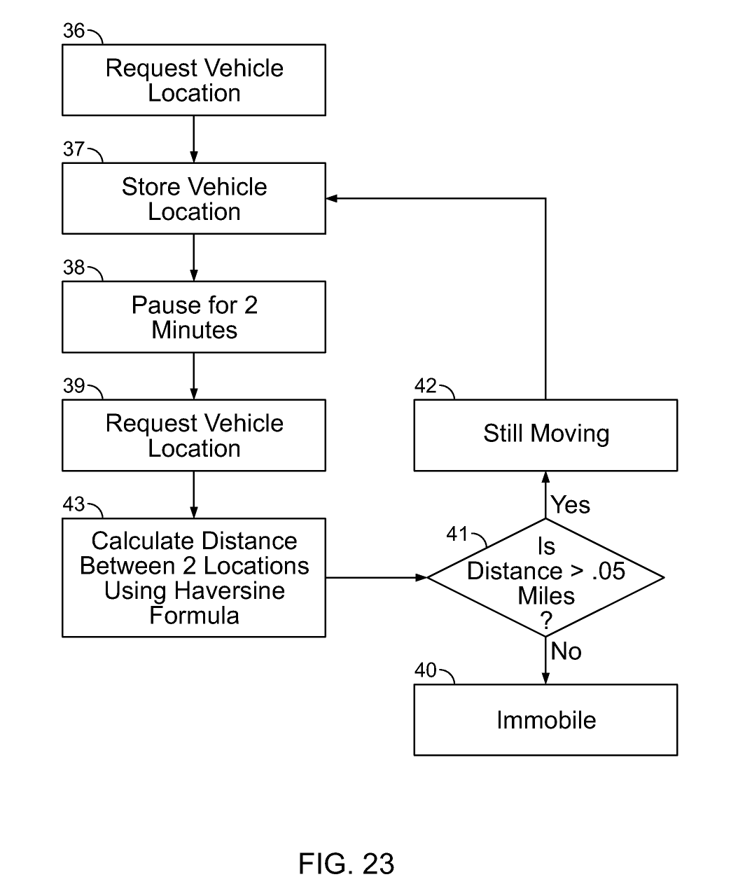

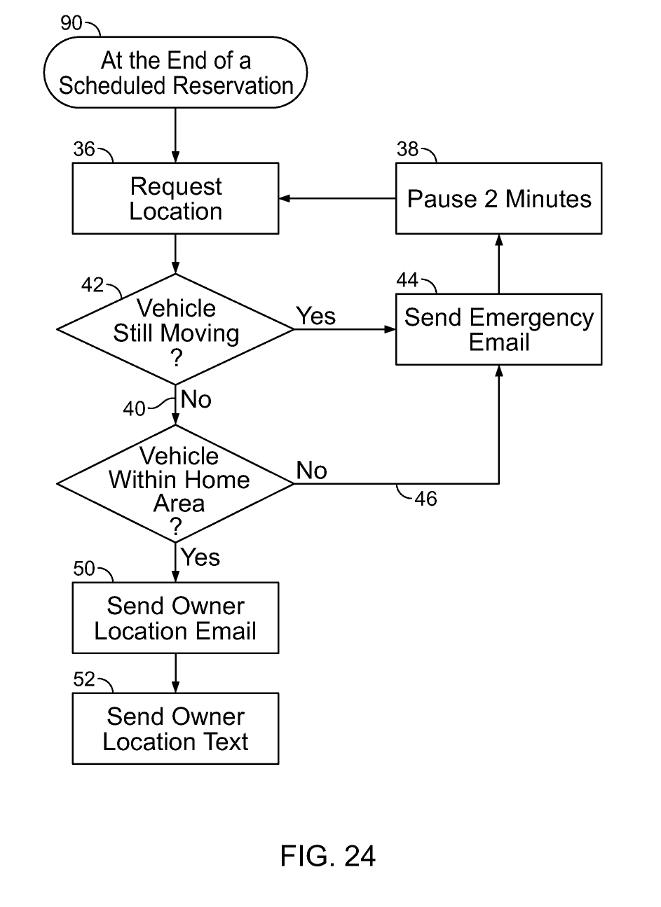

Beginning at the time when the car is supposed to have been returned (that is, at the end of the reservation period 90), the following process is executed (see especially FIGS. 23 and 24):
1) The system requests the car's location 36.
2) The system stores the location 37, and pauses 2 minutes 38.
3) The system requests 39 the car's location a second time.
4) Using a haversine formula, the system calculates 43 the distance between the two locations. If the two locations are less than 0.05 miles apart 41, the system determines the car is immobile 40. (The haversine formula is a well-known equation important in navigation, giving great-circle distances between two points on a sphere from their longitudes and latitudes. It is a special case of a more general formula in spherical trigonometry, the law of haversines, relating the sides and angles of spherical “triangles”.)
5) If the car is determined to be not immobile 42, the system sends an emergency email 44 to customer service, pauses for 2 minutes 38 and returns to step 1.
6) Once the car is determined to be immobile, if the car is further than 0.5 miles from its home location 46, the system sends an emergency email to customer service, pauses for 2 minutes, and returns to step 1.
7) When the car is immobile and within the allowable radius (the permitted zone) 50 and the end of the scheduled reservation has been reached 90, the system sends an email (and example is shown in FIG. 21) to the next borrower with a map and a specific address to locate the car. The system also sends a text message 60 (FIG. 20) to the borrower. The example email 70 in FIG. 21 includes a notice of where the car is located 72 based on, for example, GPS derived information, and a cautionary message 74 about returning the car.

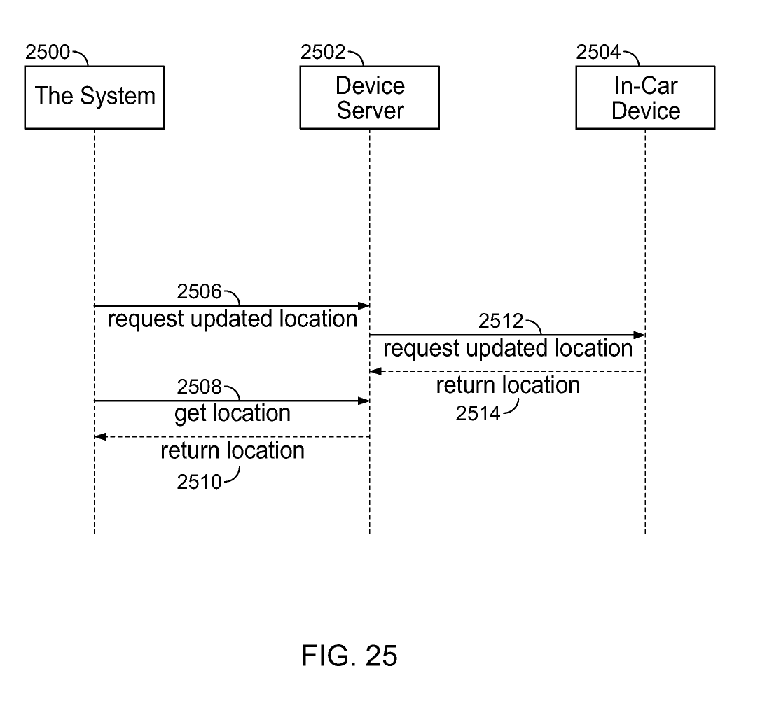

FIG. 25 illustrates a portion of the interaction among the device server 2502 (that communicates with and serves the in-car device 2504), the in-car device 2504, and the system 2500 that is managing the car sharing service, e.g., from another server. When the system needs the location of a car, it sends a message 2506 to the device server to request the location. The device server then sends a corresponding request to the in-car device.

Using, e.g., GPS, the in-car device determines its location and returns the location to the device server 2514. In turn, the device server sends a message 2510 to the system 2500 including the location. A similar sequence occurs when the system requests a location 2508 rather than an update.

Each street-parked car has a small device installed that contains a GPS, a cellular modem, and an embedded microprocessor. The device communicates with a designated device server (which is separate from the system) in two ways. If there is enough cellular service and the cellular network supports GPRS data, the in-car device communicates by making direct TCP connections to the server. If there is not an adequate cellular signal for a reliable data connection or data is not supported on that cellular network, the system will send text messages to another cellular modem that is directly attached to the server.

The device server may be hosted and its services provided by a third-party in-car technology provider. The host of the car-sharing services communicates with the device server using http requests known as RESTful web services.

In some implementations, the parking system can be a Java 5 EE application running in the Jetty servlet container. The system keeps track of reservations by storing them in a mysql database. The system has a monitoring task that checks for upcoming reservations for all street parked vehicles every 3 minutes. The system maintains the state of each reservation, location requests, location responses, emergency error emails, success emails, and the business process that is executed depending on the state.

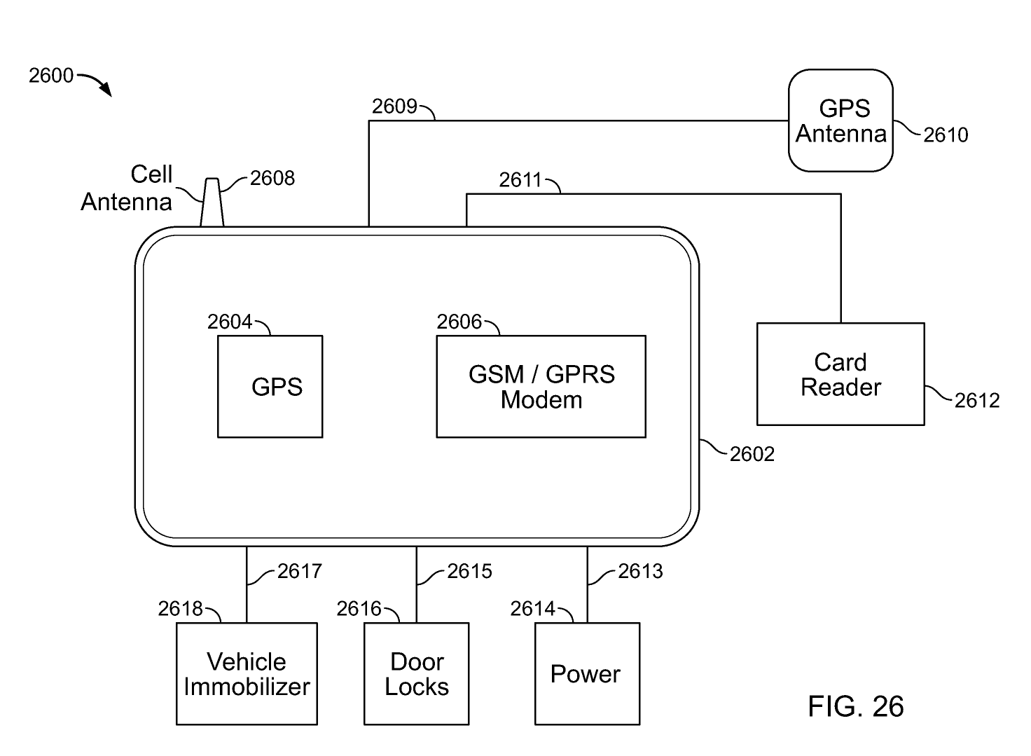

FIG. 26 is a block diagram of an example in-car device 2600 (available, for example, from Pointer Telocation Ltd. as the Compact-Fleet unit). The in-car device 2600 includes a main housing 2602, which includes a processor (not shown), a GPS receiver 2604 and a GSM/GPRS modem 2606. Attached to the main housing 2602 is a cell antenna 2608 and a GPS antenna 2610. The cell antenna 2608 is attached directly to the main body 2602. The GPS antenna 2610 is connected to the main body 2602 by a wire 2609.

The in-car device 2600 also includes a card reader 2612, connected to the main body by a wire 2611. The card reader 2612 communicates with users' access cards as described above. The in-care device 2600 also connects by wires 2613, 2615, 2617 to the car's power 2614, door locks 2616, and a vehicle immobilizer 2618. The in-car device 2600 uses these connections to lock and unlock the doors for authorized users, receive power to the in-car device 2600, and also immobilize the vehicle in the event of authorized access or attempts to remove the in-car device 2600 from the car. In some implementations, the vehicle immobilizer 2618 keeps the car immobilized until an authorized user accesses the car. The in-car device 2600 can also connect to the car's fuel sensor and horn, to receive information regarding fuel levels, and to sound the horn as an alarm, if necessary, respectively.

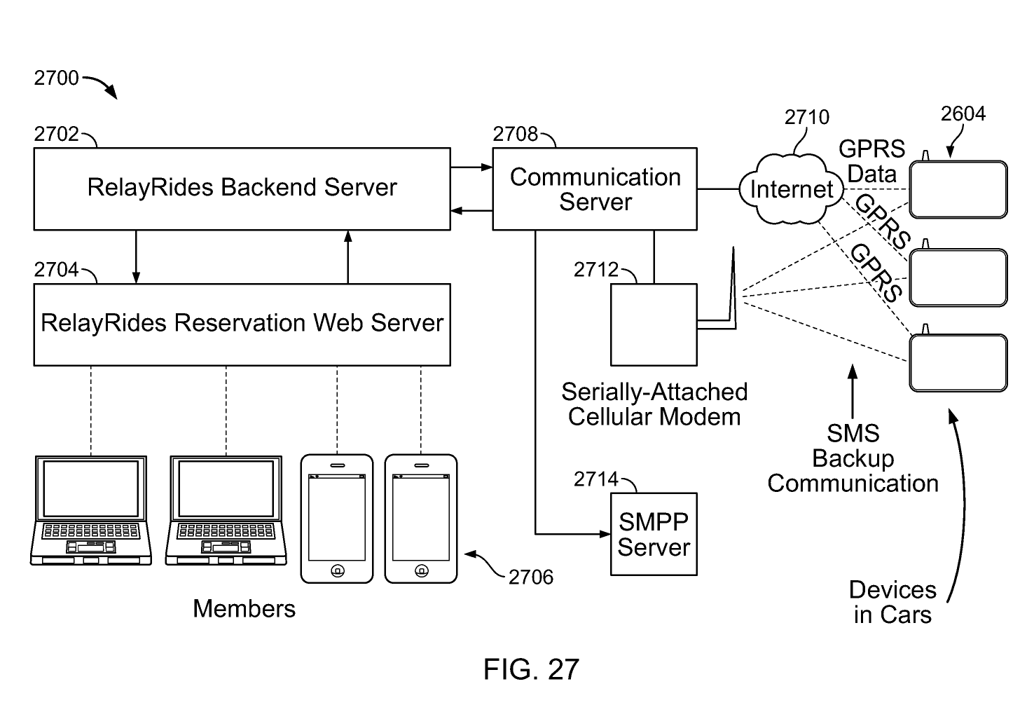

FIG. 27 is a block diagram of an example system 2700 that includes a backend server 2702, a web server 2704, a communication server 2708, a serially attached cellular modem 2712, and a short message peer-to-peer (SMPP) server 2714. User devices 2706 including computers and mobile computing devices communicate with the web server 2704. Borrowers can use the user devices 2706 to search for vehicles to borrow. The borrower uses the user device 2706 to log into the borrower's account on the web server 2704. The borrower reserves the car for a specific time. The borrower's credit card is authorized for the estimated costs. Prior to the trip the borrower is emailed the specific location if it is a street parked car, as described above. Immediately prior to the trip, the backend server 2702 gathers all unique card IDs associated with the borrower's account and sends them to the communication server 2708 to be added to the vehicle device's 2600 “whitelist.” The communication server 2708 sends the whitelist update to the device 2600 over GPRS data via the serially attached cellular modem 2712 if the device 2600 is in GPRS service range. If the device 2600 is not in GPRS service range, the communication server 2708 sends the whitelist update by short message service (SMS) via the SMPP server 2714. The device's 2600 whitelist is updated to include the borrower's card IDs.

The borrower presents her access card to the card reader of the device 2600. If the whitelist on device 2600 includes the ID of the borrower's card, the device 2600 unlocks the doors and disables the immobilizer. The borrower starts the car, uses the car as reserved, and brings the car back to the starting location. The borrower presents her card to the card reader and the device 2600 locks the doors and enables the immobilizer.

If the vehicle is at the home location and the sharing period is over, the whitelist on the device 2600 is updated again to remove the borrower's card IDs. The device 2600 communicates the number of miles driven to the communication server 2708 over GPRS or SMS, depending on what is available. The backend server 2702 determines if the borrower drove more than the allotted miles or longer than the reserved time (sharing period) and charges the original reservation costs plus any additional overage fees to the borrower. Both the owner and the borrower are prompted for feedback on the other party.

In some implementations, detailed zip-code-level analysis is done to identify favorable markets for the car-sharing system. The analysis can include a proprietary algorithm weighting, with the ability to live car-free 40%, a walkability score 10%, median income 20%, secondary education 20%, and population density 10%. Other factors and weights can be used in the algorithm.

The system provides benefits for car owners, including the ability to monetize a valuable yet underutilized asset. The average car owner is projected to make almost $5,000 a year in revenue and over $3,500 in profit. Benefits for car renters include a system that is less expensive than current options, such as other car-sharing systems, and no annual fees. The system also provides more convenient locations and more types of vehicles and features. The system provides environmental benefits such as a projected impact by year 5 of 2.4 million fewer cars on the road and 1.4 million metric ton reduction in greenhouse gas emission.

The system's business model implications include factors such as extremely rapid scaling, low investment necessary, the ability to operate profitably with low utilization rates, and feasibility to operate outside dense urban areas where traditional car-sharing services could not or would not operate.

Three key factors position the system for success: capital efficiency, attractive value proposition, and experienced management team and world-class advisors.

The problems with traditional car sharing include the capital-intensive nature and high fixed costs that have slowed the industry's growth. High fixed costs have led to financial losses, restricted geography, and slow growth. Financial losses are illustrated by facts such as existing car share programs have had trouble reaching profitability, and many small non-profit car-sharing organizations have struggled to survive. Illustrations of restricted geography include that only dense urban areas with good public transportation can support traditional car sharing, and utilization rates in suburban areas would be too low to support traditional car sharing. The high fixed costs of entering new markets has led at least one car sharing operations to focus its growth on existing cities, resulting in slow growth.

Traditional car sharing in the United States started in Portland, Oregon by Dave Brook in 1988, and has reached the mainstream in most major US cities. Traditional car sharing is a model of car rental where people rent cars for short periods of time, often by the hour. The cars are owned by a company and located in various rented parking spaces throughout the city and accessed through a self-serve mechanism. Car sharing is attractive to customers who make only occasional use of a vehicle when they need them. It is appealing to others who would like occasional access to a vehicle of a different type than they use day-to-day. Members sign up and receive an access card. Members pay an annual fee. Members book cars online, access the car with their card, and drive. Members then return the car to the original location. Traditional car-sharing differs from previous systems in that it has no office hours, it is self-service, hourly rental, users are pre-approved by members, and vehicle locations are distributed throughout the city.

The benefits of traditional car sharing include providing an on-demand mobility to members without the cost and hassle of car ownership. Reduced car ownership also leads to environmental benefits. Members can save over $500 per month, on average, by paying for a car only when needed. Environmental benefits include vehicle reduction. For every shared vehicle, 14 cars are taken off the road. Parking congestion is also reduced. The average car-sharing member reduces his driving by 40%. Members increase use of alternative forms of transportation.

The system that we describe here is the first person-to-person car-sharing marketplace, allowing ordinary people to rent their cars out to others through the system's infrastructure. The system provides an online rental marketplace, in-vehicle technology, and insurance to cover the rental period. The system's revenue includes a transaction fee, such as 15% of the rental price, monthly membership fees for owners and hourly insurance charges.

Although we have described certain examples above, implementations can use a variety of other approaches, devices, and methods. For example, other kinds of devices can be installed in cars. The permitted zone can have different sizes and shapes than the one described above. The online reservation system can provide other and additional features. The rules used to govern the determination of when the cars have reached fixed location prior to upcoming reservations could be different than the ones above, or supplement. Although we refer to cars, any kind of vehicle that can be placed near enough to a base location to suit a borrower could be used, including trucks, vans, motorcycles, bicycles, boats, or any other conveyance. In some instances, the system could also apply to rental items that are not vehicles in the classic sense. In some cases, we use the word vehicle here to refer to any such rental item whether a wheeled vehicle or not and whether or not a vehicle in the classic sense.

Some of the examples discussed above relate to individual owners and buyers, particular home locations, affinities of the home location, and reservations for cars that those affinities at requested times. More broadly, some of the same techniques could be used in systems in which the pickup locations are not necessarily in the vicinity of the home location. Systems may also be devised in which reservations are not required. Fleets of vehicles owned by very large numbers of party could be tracked and made available at a wide variety of locations from time to time for borrowers as needed.

Other implementations are also within the scope of the following claims.

For example, we have described a system that is “driven” by owners who decide to offer their cars for sharing, whether on not anyone ever borrows the cars, and then leaves it to the borrowers to decide if they want to enter into sharing transactions. A different system could be devised that is “driven” by borrowers (or a system could use both owner driven and borrower driven features in a single system). In a borrower driven system, for example, borrowers could indicate their interest in having cars available to them in certain neighborhoods and a willingness to borrow cars in that neighborhood for some predicted number of hours a year. The interest could be indicated even though it is not clear whether any owners would choose to offer their cars for sharing in that neighborhood. Owners who are members or prospective members then could see on the website that a market is available in certain neighborhoods for offering cars for sharing and could act on that information.

Also, although much of the earlier discussion assumes that users who become participants already own cars for personal use, which are then shared, it would also be possible for users to buy cars for the specific purpose of sharing them within the system.

In a densely populated area, a used car might be bought and shared at a profit to the owner.

1. A computer-implemented method comprising
through an online site, enabling owners of assets and borrowers of assets to arrange sharing transactions with respect to the assets,
confirming online to the owners and the borrowers that the arranged sharing transactions have been covered by insurance, and
using information from electronic devices associated with the assets, managing the completion of the arranged sharing transactions.

2. The method of claim 1 in which the enabling of the owners and borrowers to arrange the sharing transactions comprises enabling the owners to offer the assets at designated times or ranges of times.

3. The method of claim 1 in which the enabling of the owners and borrowers to arrange the sharing transactions comprises enabling the owners to offer the assets at designated places.

4. The method of claim 1 in which the enabling of the owners and borrowers to arrange the sharing transactions comprises enabling the borrowers to express their interest in borrowing assets at designated times or ranges of times.

5. The method of claim 1 in which the enabling of the owners and borrowers to arrange the sharing transactions comprises enabling the borrowers to express their interest in borrowing assets at designated places.

6. The method of claim 1 in which the assets comprise vehicles.

7. The method of claim 1 in which the assets comprise cars.

8. The method of claim 1 in which each of the assets has a home location, and the sharing transaction begins, ends, or both at the home location.

9. The method of claim 1 in which the owner and borrower in a given transaction live near to one another.

10. The method of claim 1 in which each of the sharing transactions is defined in terms of a time period during which the asset is to be shared with the borrower.

11. The method of claim 1 in which the online site enables borrowers to identify assets that are to be the subjects of the sharing transactions and identifies times or ranges of times for the sharing transactions.

12. The method of claim 1 in which the online site enables owners to identify assets that are to be the subjects of the sharing transactions and identifies times or ranges of times for the sharing transactions.

13. The method of claim 1 in which the electronic devices track the locations of the assets.

14. The method of claim 1 in which the sharing transactions involve periods of time shorter than one day.

15. The method of claim 1 in which the sharing transactions carry fees paid by the borrowers for the benefit of the owners.

16. A computer-implemented car-sharing method comprising
through an online site, enabling owners of cars to offer them for sharing at designated times and in designated home locations, for money,
through an online site, enabling borrowers of cars to arrange to available borrow cars at the designated times and in the designated home locations, for money,
providing for insurance to apply to the sharing of the cars,
using information received from electronics about the locations and identities of the cars, to manage the execution of the sharing of the cars.

17. A computer-based method comprising
receiving ongoing information about assets that belong to respective owners and are available for borrowing,
determining whether the respective assets will be immobile and available for borrowing at specific times in the vicinities of specific locations, and
informing prospective borrowers of the locations and times at which the respective assets will be immobile and available for borrowing.

18. The method of claim 17 in which the assets comprise vehicles.

19. The method of claim 1 including
receiving information about reservations from prospective borrowers of the assets, each of the reservations identifying a time when the borrower wants to pick up a vehicle and a geographical vicinity in which he wants to pick up the vehicle at that time.

20. The method of claim 19 including informing a prospective borrower when a vehicle is available at a time and in a vicinity that corresponds to a reservation of the borrower.

21. The method of claim 19 in which the reservations are received at an online site.

22. The method of claim 17 in which the assets are privately owned.

23. The method of claim 17 in which the assets comprise cars.

24. The method of claim 17 in which the time when the borrower wants to pick up an asset is a specific time.

25. The method of claim 17 in which the time when the borrower wants to pick up an asset is a range of times.

26. The method of claim 17 in which the geographical vicinity is associated with a specific home location.

27. The method of claim 17 in which the geographical vicinity contains a specific home location.

28. The method of claim 27 in which the home location comprises a home of an owner of the asset.

29. The method of claim 17 including determining whether each of the assets is immobile by determining whether the asset has moved at least a certain distance within a predefined period of time.

30. The method of claim 17 in which the information about the locations of assets is generated by GPS.

31. The method of claim 17 in which determining whether the asset will be immobile within the vicinity at the time when the borrower wants to pick it up is based on information about reservations made by borrowers for the assets.

32. The method of claim 17 including notifying a borrower of the location at which the asset is immobile once the determination has been made that the asset will be immobile at that location and the intended time,

33. The method of claim 17 in which the prospective borrowers are notified by sending them messages.

34. A car that is owned by a private individual and carries electronics to send information to a car sharing service that includes the location of the car and an identifier of the car.
